(19) United States
(12) Patent Application Publication
(10) Pub. No.: US 2006/0046838 A1
(43) Pub. Date: Mar. 2, 2006

(54) Method and system for gaming and e-materials distribution

(75) Inventors: Craig A. Paulsen, Reno, NV (US); Binh T. Nguyen, Reno, NV (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: IGT., a Nevada corporation, Reno, NV (US)

(21) Appl. No.: 10/933,631

(22) Filed: Sep. 2, 2004

(51) Int. Cl. G06F 17/00; G06F 19/00

(52) U.S. Cl. 463/25

(57) ABSTRACT

A gaming method includes determining if a first event has occurred, distributing an e-coupon to a player if the first event has occurred, the e-coupon being storable on a machine accessible medium, having an identifier associated therewith, and redeemable for a payout, associating a first payout with the identifier according to the first event, determining if a second event has occurred, and associating a second payout with the identifier according to the second event, the second payout being different than the first payout and the first payout no longer associated with the identifier.

### BACKGROUND

This patent is directed to the distribution of electronically stored materials, and in particular to the distribution of electronically stored materials in conjunction with gaming activities.

### SUMMARY OF THE INVENTION

In an aspect, a gaming method includes determining if a first event has occurred, distributing an e-coupon to a player if the first event has occurred, the e-coupon being storable on a machine accessible medium, having an identifier associated therewith, and redeemable for a payout, associating a first payout with the identifier according to the first event, determining if a second event has occurred, and associating a second payout with the identifier according to the second event, the second payout being different than the first payout and the first payout no longer associated with the identifier.

In another aspect, a gaming system includes a distribution computer having a processor and memory operatively coupled to the processor. The distribution computer is programmed to determine if a first event has occurred, to distribute an e-coupon to a player if the first event has occurred, the e-coupon being storable on a machine accessible medium, having, an identifier associated therewith, and redeemable for a payout, to associate a first payout with the identifier according to the first event, to determine if a second event has occurred, and to associate a second payout with the identifier according to the second event, the second payout being different than the first payout and the first payout no longer associated with the identifier.

Additional aspects of the disclosure are defined by the claims of this patent.

### BRIEF DESCRIPTION OF THE DRAWINGS

FIG. 1 is a block diagram of an embodiment of a gaming and distribution system in accordance with the invention;

FIG. 1A is a block diagram of an embodiment of a distribution aspect of the gaming and distribution system of FIG. 1;

FIG. 2 is a perspective view of an embodiment of one of the gaming units shown schematically in FIG. 1;

FIG. 2A illustrates an embodiment of a control panel for a gaming unit;

FIG. 3 is a block diagram of the electronic components of the gaming unit of FIG. 2;

FIG. 4 is a flowchart of an embodiment of a main distribution routine that may be performed during operation of the distribution aspect of the system of FIG. 1;

FIG. 5 is a flowchart of an embodiment of a registration routine that may be performed during operation of the main distribution routine of FIG. 4;

FIG. 6 is a flowchart of any embodiment of a redemption routine that may be preformed during operation of the distribution aspect of the system of FIG. 1;

FIG. 7 is a flowchart of an embodiment of a main gaming routine that may be performed during operation of one or more of the gaming units;

FIG. 8 is a flowchart of an embodiment of a verification routine that may be performed during the operation of the main gaming routine of FIG. 7;

FIG. 9 is a flowchart of an alternative embodiment of a main gaming routine that may be performed during operation of one or more of the gaming units;

FIG. 10 is an illustration of an embodiment of a visual display that may be displayed during performance of the video poker routine of FIG. 12;

FIG. 11 is an illustration of an embodiment of a visual display that may be displayed during performance of the video blackjack routine of FIG. 13;

FIG. 12 is a flowchart of an embodiment of a video poker routine that may be performed by one or more of the gaming units;

FIG. 13 is a flowchart of an embodiment of a video blackjack routine that may be performed by one or more of the gaming units;

FIG. 14 is an illustration of an embodiment of a visual display that may be displayed during performance of the slots routine of FIG. 16;

FIG. 15 is an illustration of an embodiment of a visual display that may be displayed during performance of the video keno routine of FIG. 17;

FIG. 16 is a flowchart of an embodiment of a slots routine that may be performed by one or more of the gaming units;

FIG. 17 is a flowchart of an embodiment of a video keno routine that may be performed by one or more of the gaming units;

FIG. 18 is an illustration of an embodiment of a visual display that may be displayed during performance of the video bingo routine of FIG. 19; and

FIG. 19 is a flowchart of an embodiment of a video bingo routine that may be performed by one or more of the gaming units.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

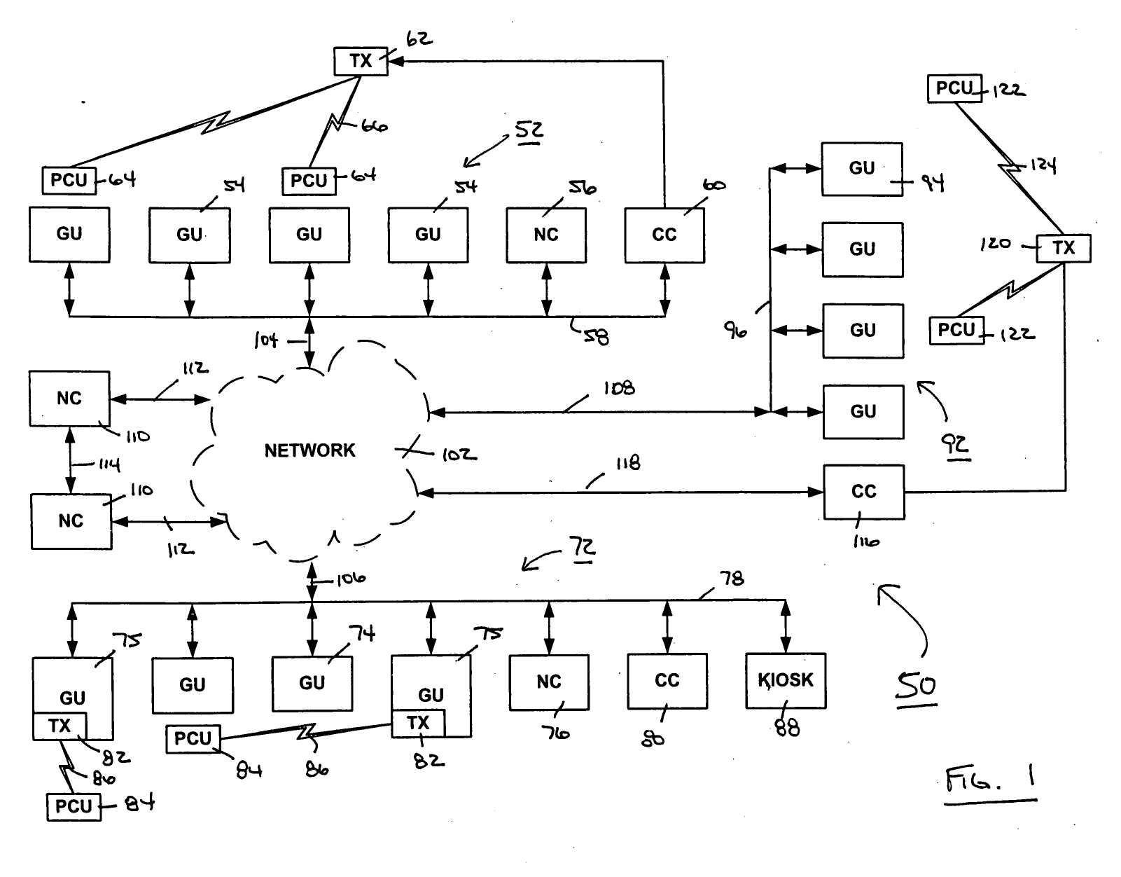

FIG. 1 illustrates one possible embodiment of a casino gaming and distribution system 50 (hereinafter “system 50”) in accordance with the disclosure. Referring to FIG. 1, the system 50 may include a first group or network 52 of casino gaming units 54 operatively coupled to a network computer 56 via a network data link or a bus 58. The first network 52 may also include a communications computer 60, which may be coupled to the network computer 56 via the data link or bus 58. The communications computer 60 may also be coupled to a transceiver 62, which transceiver may be a wireless transceiver, such as a radio frequency transceiver or infrared transceiver, for example. The transceiver 62 may be in communication with one or more personal communication units 64 (such as a Personal Digital Assistant or the like, having a controller including a processor and memory operatively coupled to the processor), a data link 66 being formed according to the method of communication used (e.g., radio frequency, infrared, etc.). The personal communication units 64 may be owned by the player, or may be provided to the player by the operator of the network 52.

The system 50 may include a second group or network 72 of casino gaming units 74, 75 operatively coupled to a network computer 76 via a network data link or a bus 78. The second network 72 may also include a communications computer 80, which may be coupled to the network computer 76 via the data link or bus 78. The communications computer 80 may also be coupled via the data link or bus 78 to transceivers 82 that are attached to or integrated with the gaming units 75, which transceivers may be wireless transceivers, such as a radio frequency transceivers or infrared transceivers, for example. The transceivers 82 may be in communication with one or more personal communication units 84, a data link 86 being formed according to the method of communication used (e.g., radio frequency, infrared, etc.). The personal communication units 84 may be owned by the player, or may be provided to the player by the operator of the network 72. The second network 72 may also include a kiosk 88.

The system 50 may further include a third group or network 92 of casino gaming units 94. The gaming units 94 may be coupled via a data link or a bus 96. The third network 92 differs from the first and second networks in that there is no network computer coupled to the data link 96.

The first, second, and third gaming networks 52, 72, 92 may be operatively coupled to each other via a fourth network 102, which may comprise, for example, the Internet, an intranet, a wide area network (WAN), or a local area network (LAN). The network 102 may include a plurality of network computers or server computers (not shown), each of which may be operatively interconnected. The first, second and third networks 52, 72, 92 may be coupled to the fourth network 102 via a first, second, and third data links 104, 106, 108. Where the network 102 comprises an Intranet or the Internet, data communication may take place over the communication links 104, 106, 108 via an Internet communication protocol.

The fourth network may also be coupled to other computers or networks other than the first, second and third networks 52, 72, 92 discussed above. For example, the fourth network may be coupled to one or more other network computers 110, via data links 112. These network computers may, in turn, be coupled via data links 114. Additionally, the fourth network may be coupled to a communications computer 116 via a data link 118, the communications computer being coupled to a transceiver 120. The transceiver 120 is shown in communication with personal communication units 122, which may be in the same geographic location as the gaming units 94 of the network 92 via a data link 124 formed according to the method of communication used (e.g. radio frequency, infrared, etc.). The personal communication units 122 may be owned by the player, or may be provided to the player by the operator of the network 92.

The network computer 56 may be a server. According to one embodiment, the network computer 56 may be used as an accounting system server to accumulate and analyze data relating to the operation of the gaming units 54. For example, the network computer 56 may continuously receive data from each of the gaming units 54 indicative of the dollar amount and number of wagers being made on each of the gaming units 54, data indicative of how much each of the gaming units 54 is paying out in winnings, etc. According to another embodiment, the network computer 56 may be used as a player tracking server or a bonusing server to accumulate and analyze data relating to the operation of particular gaming units 54. According to this embodiment, the network computer 56 may receive data from a particular gaming unit 54 indicative of the identity of the player operating the gaming unit 54, the number of wagers being made on the gaming unit 54, etc. If the network computer 56 is being used as a player tracking server, the network computer 56 may use the data accumulated to award player tracking points to the player, which points may be used to assess comps or to be redeemed for goods or services. If the network computer is being used as a bonusing computer, the network computer 56 may use the data accumulated to award the player prizes, which may be goods or services, based on individual or collective performance, to award bonusing points which points may be redeemed for goods or services, etc. According to a still further embodiment, the network computer 56 may be used as a download server to monitor the software implemented by and the data utilized by the gaming units 54, to determine if software or data upgrades are available, and to download the upgrades to the gaming units 54. According to yet another embodiment, the network computer 56 may be used as an e-materials distribution server, as will be explained in greater detail with reference to FIG. 1A, below.

The network computer 76 may be a server and may be used to perform the same or different functions in relation to the gaming units 74, 75 as the network computer 56 described above. Similarly, the network computers 110 may be servers, and may be used to perform the same or different functions in relation to the gaming units 54, 74, 75, 94 as the network computers 56, 76. Moreover, the network computers 110 may be different servers, and may perform the same or different functions in relation to the gaming units 54, 74, 75, 94.

As an alternative, the operation of the gaming units may be monitored and/or coordinated without the use of a central computer or controller, as in the third network 92. During operation, the processing required by the operations otherwise performed by a network computer may be shared by the gaming units 94. Such shared processing may be referred to as peer-to-peer networking, and is also within the scope of the present disclosure.

The communications computers 60, 80 may also be servers. That is, the computers 60, 80 may monitor and coordinate the communications between other computers, such as the network computers 56, 76, and the personal communication devices 64, 84 via the transceivers 62, 82. Alternatively, as in the case of the communications computer 116, the communications computer may be part of a mobile communications network that is operated and administered by an entity other than the entity that operates and administers the network of gaming units, such as gaming units 94. Such a mobile communications network may be a cellular telephone network, and the communications computer 116 may represent the base station system of such a network, which base station system may be in communication with the Internet via a gateway, for example. According to this embodiment, the personal communication units 122 may be mobile stations, such as cellular telephones, portable e-mail devices (e.g. BLACKBERRY® devices manufactured by Research In Motion Ltd., of Waterloo, Ontario, Canada), personal digital assistants (PDA), laptops, tablet personal computers, etc.

The first network 52 of gaming units 54 may be provided in a first casino, the second network 72 of gaming units 74 may be provided in a second casino located in a separate geographic location than the first casino, and the third network 92 of gaming units 94 may be provided in a third casino in a separate geographic location that the first and the second networks. For example, the three casinos may be located in different areas of the same city, or they may be located in different states. However, the three networks 52, 72, 92 may be disposed in different sections of the same casino, or the gaming units 54, 74, 75, and 94 may even be disposed in the same section of the same casino.

Although the networks 52, 72 are shown as including one network computer 56, 76, one communications computer 60, 80, and four gaming units 54, 64 and the network 92 as including four gaming units 94, it should be understood that different numbers of computers and gaming units may be utilized. For example, the network 52 may include a plurality of network computers 56 and tens or hundreds of gaming units 54, all of which may be interconnected via the data link 58. The data link 58 may be provided as a dedicated hardwired link, a wireless link, a fiber optic link, or a network (LAN, WAN, Internet, intranet) connection. Although the data link 58 is shown as a single data link 58, the data link 58 may comprise multiple data links. Similarly, multiple kiosks 88 may also be included.

FIG. 1A is one embodiment of the system 50, as seen from the point of view of the distribution aspect of the system 50. As such, many of the elements of the system 50 referenced in FIG. 1A correspond to one or more of the elements described with reference to FIG. 1. However, as more than one of the elements described in FIG. 1 may correspond to the elements shown in FIG. 1A, the elements of FIG. 1A have been numbered separately, and the correspondences addressed in turn in detail below.

As seen in FIG. 1A, the system 50 may include several servers 130, 132, 134, 136, 138, 140, 142. These servers 130, 132, 134, 136, 138, 140, 142 may correspond to one or more of the network computers 56, 76, 110 or the communications computers 60, 80, or, alternatively, the processing of these servers may be shared by gaming units, as in the network 92. The servers are as follows: an e-materials distribution server 130, a player tracking server 132, a gaming unit download server 134, a communication server 136, a remote access server 138, an offsite intranet server 140, and an Internet server 142.

The servers 130, 132, 134, 136, 138, 140, 142 may be connected by one or more data links and one or more networks. According to the embodiment shown, the e-materials distribution server 130 is coupled via a data link 144 and a network 146 to the player tracking server 132, the gaming unit download server 134, and the communication server 136 via the data links 148, 150, 152. The e-materials distribution server 130 is also coupled via a data link 154 to the remote access server 138, which is in turn coupled via a data link 156 to the intranet server 140 and the Internet server 142. In turn, the intranet server 140 is connected via a data link 158 to an intranet 160, and the Internet server 142 is connected via a data link 162 to the Internet 164.

Additionally, certain of the servers may be coupled to other elements, such as player tracking modules, gaming units, and personal communication units. For example, the player tracking server 132 (which may be one of the network computers 56, 76, 110) is coupled, via data link 166, to player tracking modules 168. These player tracking modules 168 may be associated with the gaming units 54, 74, 75, 94, and are discussed in greater detail below. Similarly, the gaming unit download server 134 (which may be one of the network computers 56, 76, 116) is coupled, via data link 170, to gaming units 172, which may be the gaming units 54, 74, 75, 94. Further, the communications server 136 (which may be one of the communications computers 60, 80) may be in communication with, via data links 174, 176, personal communication units 178, which may be the personal communication units 64, 84. Additionally, the Internet server 142 may be in communication with, via data links 180, 182, gaming units 184, 186.

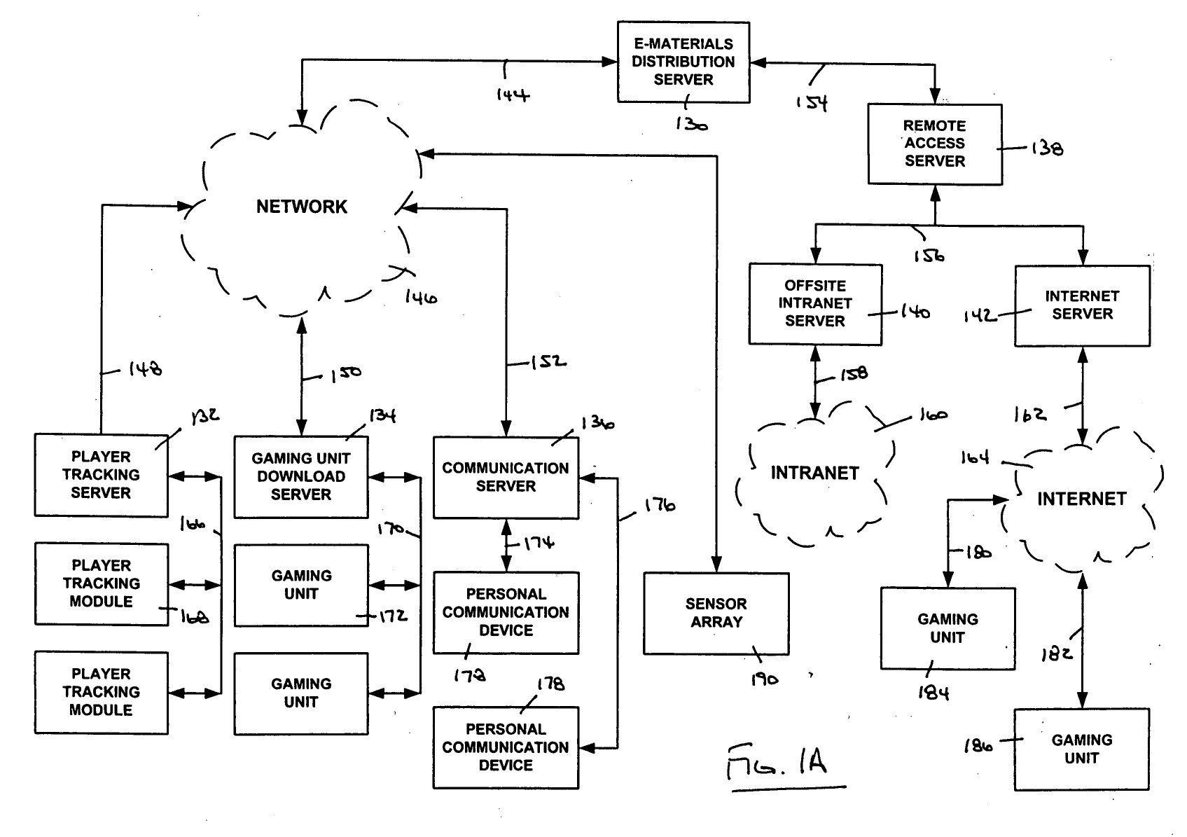

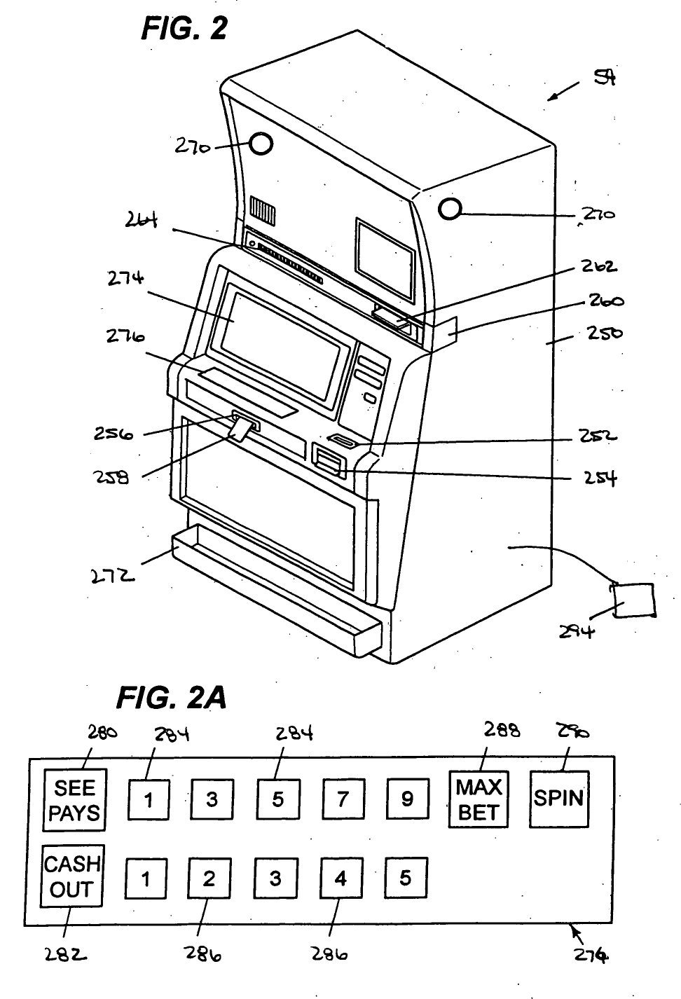

FIG. 2 is a perspective view of one possible embodiment of one or more of the gaming units 54. Although the following description addresses the design of the gaming units 54, it should be understood that the gaming units 74, 75, 94 may have the same design as the gaming units 54 described below. It should be understood that the design of one or more of the gaming units 54 may be different than the design of other gaming units 54, and that the design of one or more of the gaming units 74, 75, 94 may be different than the design of other gaming units 74, 75, 94. Each gaming unit 54 may be any type of casino gaming unit and may have various different structures and methods of operation. For exemplary purposes, various designs of the gaming units 54 (and 75) are described below, but it should be understood that numerous other designs may be utilized.

Referring to FIG. 2, the casino gaming unit 54 may include a housing or cabinet 250 and one or more value input devices, which may include a coin slot or acceptor 252, a paper currency acceptor 254, and a ticket reader/printer 256. The value input device may also be a card reader (not shown). A value input device may include any device that can accept value from or transfer value for a player, and may be disposed on the front of the gaming unit 54 or in any other suitable location. As used herein, the term “value” may encompass money denominations or credits, and may be in the form of coins, paper currency, gaming tokens, ticket vouchers, credit or debit cards, smart cards, electronic funds transfers (EFT) and any other object representative of value.

Some of the value input devices may also operate as value output devices. For example, if provided on the gaming unit 54, the ticket reader/printer 256 may be used to print or otherwise encode ticket vouchers 258. The ticket vouchers 258 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 258 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 258 could be printed with an optically readable material such as ink, or data on the ticket vouchers 258 could be magnetically encoded. The ticket reader/printer 256 may be provided with the ability to both read and print ticket vouchers 258, or it may be provided with the ability to only read or only print or encode ticket vouchers 258. In the latter case, for example, some of the gaming units 54 may have ticket printers 256 that may be used to print ticket vouchers 258, which could then be used by a player in other gaming units 54 that have ticket readers 256.

As another alternative, an electronic funds transfer (EFT) device (not shown) may operate as both a value input device and a value output device. Such an EFT device may include a circuit capable of performing or a controller programmed to perform an electronic funds transfer (EFT) to the player's bank account or to a virtual account established, for example, on a PDA or at a casino. Such a transfer may be performed over a hardwired, wireless, fiber optic or network connection. As such a device is capable of transferring money to and from the gaming unit 54, it may operate either as a value input device or a value output device.

Also attached to the gaming unit 54 is a player tracking module 260, which may be the player tracking module 168 referred to in FIG. 1A. The player tracking module 260 includes a card reader 262 and a display 264. The card reader 262 may include any type of card reading device, such as a magnetic card reader or an optical card reader, and may be used to read data from a card offered by a player, such as a player tracking card. The card reader 262 may be used to read data from, and/or write data to, player tracking cards that are capable of storing data representing the identity of a player, the identity of a casino, the player's gaming habits, etc. The display 264 may be a liquid crystal display (LCD), a vacuum fluorescent display (VFD),an array of LED elements, etc. The display 264 may be used to display messages particular to the player tracking system, or may be controlled by the gaming unit 54 or other servers to display messages particular to the operation of the gaming unit 54 or other systems (such as, for example, bonusing messages from a bonusing system).

The gaming unit 54 may include one or more audio speakers 270, a coin payout tray 272, a display unit 274, and an input control panel 276. The audio speakers 270 may generate audio representing sounds such as the noise of spinning slot machine reels, a dealer's voice, music, announcements or any other audio related to a casino game. Where the gaming unit 54 is designed to facilitate play of a video casino game, such as video poker or video slots, the display unit 274 may be a color video display unit that displays images relating to the particular game or games. Where the gaming unit 54 is designed to facilitate play of a reel-type slot machine, the display unit 274 may comprise a plurality of mechanical reels that are rotatable, with each of the reels having a plurality of reel images disposed thereon. The input control panel 276 may be provided with a plurality of pushbuttons or touch-sensitive areas that may be pressed by a player to select games, make wagers, make gaming decisions, etc.

FIG. 2A illustrates one possible embodiment of the control panel 276, which may be used where the gaming unit 54 is a slot machine having a plurality of mechanical, electro-mechanical or electronic (i.e., as represented on a video display unit) reels. Referring to FIG. 2A, if the display unit 274 is provided in the form of a video display unit, the control panel 276 may include a “See Pays” button 280 that, when activated, causes the display unit 274 to generate one or more display screens showing the odds or payout information for the game or games provided by the gaming unit 54. As used herein, the term “button” is intended to encompass any device that allows a player to make an input, such as an input device that must be depressed to make an input selection or a display area that a player may simply touch. The control panel 276 may include a “Cash Out” button 282 that may be activated when a player decides to terminate play on the gaming unit 54, in which case the gaming unit 54 may return value to the player, such as by returning a number of coins to the player via the payout tray 272.

If the gaming unit 54 provides a slots game having a plurality of reels and a plurality of paylines which define winning combinations of reel symbols, the control panel 276 may be provided with a plurality of selection buttons 284, each of which allows the player to select a different number of paylines prior to spinning the reels. For example, five buttons 284 may be provided, each of which may allow a player to select one, three, five, seven or nine paylines.

If the gaming unit 54 provides a slots game having a plurality of reels, the control panel 276 may be provided with a plurality of selection buttons 286 each of which allows a player to specify a wager amount for each payline selected. For example, if the smallest wager accepted by the gaming unit 54 is a quarter ($0.25), the gaming unit 54 may be provided with five selection buttons 286, each of which may allow a player to select one, two, three, four or five quarters to wager for each payline selected. In that case, if a player were to activate the “5” button 284 (meaning that five paylines were to be played on the next spin of the reels) and then activate the “3” button 286 (meaning that three coins per payline were to be wagered), the total wager would be $3.75 (assuming the minimum bet was $0.25).

The control panel 276 may include a “Max Bet” button 288 to allow a player to make the maximum wager allowable for a game. In the above example, where up to nine paylines were provided and up to five quarters could be wagered for each payline selected, the maximum wager would be 45 quarters, or $11.25. The control panel 276 may include a spin button 290 to allow the player to initiate spinning of the reels of a slots game after a wager has been made.

In FIG. 2A, a rectangle is shown around the buttons 280, 282, 284, 286, 288, 290. It should be understood that that rectangle simply designates, for ease of reference, an area in which the buttons 280, 282, 284, 286, 288, 290 may be located. Consequently, the term “control panel” should not be construed to imply that a panel or plate separate from the housing 250 of the gaming unit 54 is required, and the term “control panel” may encompass a plurality or grouping of player activatable buttons.

Although one possible control panel 276 is described above, it should be understood that different buttons could be utilized in the control panel 276, and that the particular buttons used may depend on the game or games that could be played on the gaming unit 54. If the display unit 274 is provided as a video display unit, the control panel 276 could be generated by the display unit 274. In that case, each of the buttons of the control panel 276 could be a colored area generated by the display unit 274, and some type of mechanism may be associated with the display unit 274 to detect when each of the buttons was touched, such as a touch-sensitive screen.

The gaming unit 54 may also include a mechanism 294 by which the gaming unit 54 may determine the identity of the player. This mechanism may be separate from the other elements of the gaming unit 54, may be incorporated into one of the other elements of the gaming unit 54, or its function may be provided by one of the other elements of the gaming unit 54. As an example of the latter category, the card reader 262 may be used to read a card that carries an identification code that may be uniquely associated with the player so that the gaming unit 54 can differentiate that player from all other players, or so that the gaming unit 54 can differentiate that player as a member of a group of players from all players not a member of the group of players. In FIG. 2, a separate identification device 294 is illustrated.

The identification device 294 may include equipment, such as a keypad, an input pad (with optional stylus), a port (or antenna) adapted to communicate via a wired or wireless link (infrared or radio frequency link, for example) to a Personal Digital Assistant (PDA), a camera, a scanner, a retinal (or iris) scanner, fingerprint scanner, and/or a microphone. The identification device 294 may include any one of these devices, or the identification device 294 may include a combination of some or all of these devices. Thus, utilizing the identification device 294, a player may identify him or herself by entering a unique numeric or alpha-numeric code using the key pad, for example. Alternatively, the player may use his or her finger or the stylus to sign his or her signature on the input pad. The pad and/or stylus may include instrumentation to record such characteristics as position, form, speed, and/or pressure as the player signs his or her signature. As a further alternative, the player may sign his or her signature on the Personal Digital Assistant, which signature is then converted to electronic data, and the data is then transferred via the port/antenna to the identification device 294. As yet another alternative, the player may sign his or her signature on a piece of paper that is then photographed using the camera or scanned using the scanner (or the bill acceptor 254) to convert the signature into electronic data. As an additional alternative, the player may place one of his or her fingers or his or her hand on the scanner, and the scanner may generate an electronic data representation of the fingerprint on one or more of the player's fingers or an electronic data representation of the pattern of the entire hand. Alternatively, the camera may be used to take a picture (live or still) of the player, the picture then being converted into electronic data. As a still further alternative, the player may place his or her eye up to the retinal (or iris) scanner, and the retinal (or iris) scanner may generate an electronic data representation corresponding to the pattern of the retina (or iris) of the player. As yet another alternative, the player may speak into the microphone, and characteristics of the spoken words (or voiceprint) may be converted into an electronic data representation.

Other equipment may also be used in conjunction with the identification device 294. For example, rather than using a stylus, a mouse or glove may be used. Additionally, thermal imaging equipment may be included or substituted. Moreover, a touchscreen may be integrated with the display unit 274 and used, in place of the input pad, in combination with a stylus or a finger, for example.

### Gaming Unit Electronics

FIG. 3 is a block diagram of a number of components that may be incorporated in the gaming unit 54. Referring to FIG. 3, the gaming unit 54 may include a controller 310 that may comprise a program memory 312, a microcontroller or microprocessor (MP) 314, a random-access memory (RAM) 316 and an input/output (I/O) circuit 318, all of which may be interconnected via an address/data bus 320. It should be appreciated that although only one microprocessor 314 is shown, the controller 310 may include multiple microprocessors 314. Similarly, the memory of the controller 310 may include multiple RAMs 316 and multiple program memories 312. Although the I/O circuit 318 is shown as a single block, it should be appreciated that the I/O circuit 318 may include a number of different types of I/O circuits. The RAM(s) 316 and program memories 312 may be implemented as semiconductor memories, magnetically readable memories, and/or optically readable memories, for example.

Although the program memory 312 is shown in FIG. 3 as a read-only memory (ROM) 312, the program memory of the controller 310 may be a read/write or alterable memory, such as a hard disk. In the event a hard disk is used as a program memory, the address/data bus 320 shown schematically in FIG. 3 may comprise multiple address/data buses, which may be of different types, and there may be an I/O circuit disposed between the address/data buses.

Furthermore, while the controller 310 is shown as a dashed box surrounding the memories 312, 316, processor 314, and I/O circuit 318, this should not be interpreted as a physical limitation on the controller 310. The memories 312, 316 and processor 314 may be disposed on a single board, or they may be disposed on separate boards. Similarly, the I/O circuit 318 may be disposed on the same board as the memories 312, 316 and processor 314, or may be disposed on a separate board.

FIG. 3 illustrates that the coin acceptor 252, the bill acceptor 254, the ticket reader/printer 256, the player tracking module 260, the display unit 274, the control panel 276, and the identification device 294 may be operatively coupled to the I/O circuit 318, each of those components being so coupled by either a unidirectional or bidirectional, single-line or multiple-line data link, which may depend on the design of the component that is used. The speaker(s) 270 may be operatively coupled to a sound circuit 322, that may comprise a voice- and sound-synthesis circuit or that may comprise a driver circuit. The sound-generating circuit 322 may be coupled to the I/O circuit 318. Additionally, for a gaming unit such as the gaming unit 75, the transceiver 82 may also be coupled to the I/O circuit 318.

As shown in FIG. 3, the components 252, 254, 256, 260, 274, 276, 294, 322 (and, optionally, 82) may be connected to the I/O circuit 318 via a respective direct line or conductor. Different connection schemes could be used. For example, one or more of the components shown in FIG. 3 may be connected to the I/O circuit 318 via a common bus or other data link that is shared by a number of components. Furthermore, some of the components may be directly connected to the microprocessor 314 without passing through the I/O circuit 318.

### Overall Operation of System

One manner in which the system 50 and one or more of the gaming units 54 (and one or more of the gaming units 74, 75, 94) may operate is described below in connection with a number of flowcharts which may be implemented as a number of portions or routines of one or more computer programs. These programs or portions of programs may be represented as a set of instructions that may be carried out by one or more of the servers 130-142 and/or the controller 310 of gaming units 54, 74, 75, 94, for example.

The programs or portions of programs may be written in any high level language such as C, C++, C#, Java, Visual Basic or the like, or any low-level assembly or machine language. The programs or portions of programs may include data files, binary files, scripts, data tables, graphic file formats, 3D models, etc. Furthermore, the programs or portions of programs may be implemented using an event-based triggering system. That is, the controller 310, for example, may generate an event (for example, in connection with a game outcome) that is in turn communicated to the display unit 274, the sound circuit 322, and a payout device, for example, the ticket reader/printer 256. Each unit or device may then determine if the communicated event has significance for that unit or device, and what that significance may be. As a result, units or device may be added or removed from the gaming unit 54 without requiring significant reprogramming of the controller 310, thereby permitting a modular approach to be implemented.

It will also be recognized that the programs or portions of programs may be stored on a machine accessible medium. A machine accessible medium includes any mechanism that provides (i.e., stores and/or transmits) information in a form accessible by a machine (e.g., a computer, network device, personal digital assistant, any device with a set of one or more processors, etc.). For example, a machine accessible medium includes recordable/non-recordable magnetic, optical and solid-state media (e.g., read only memory (ROM), programmable read only memory (PROM), erasable programmable read only memory (EPROM), electrically erasable programmable read only memory (EEPROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. According to the present embodiment, the machine-accessible medium may include the memories associated with the servers 130-142 and the memories 312, 316 of the controller 310.

In regard to the gaming units 54 (and gaming units 74, 75, 94), the programs or portions of programs may be stored remotely, outside of the gaming unit 54, and may control the operation of the gaming unit 54 from a remote location. Such remote control may be facilitated with the use of a wireless connection, or by an Internet interface that connects the gaming unit 54 with a remote computer (such as the network computer 56) having a memory in which the computer program portions are stored. By storing the programs or portions of programs therein, various portions of the memories are physically and/or structurally configured in accordance with the instructions of the programs or portions of programs.

### Main Distribution Routine

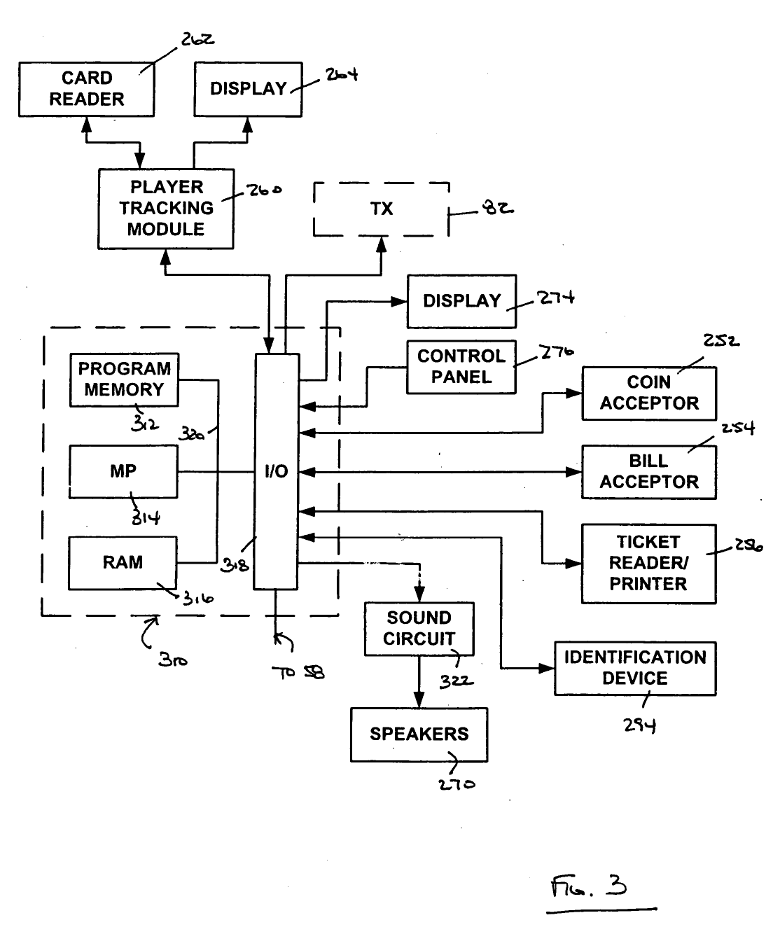

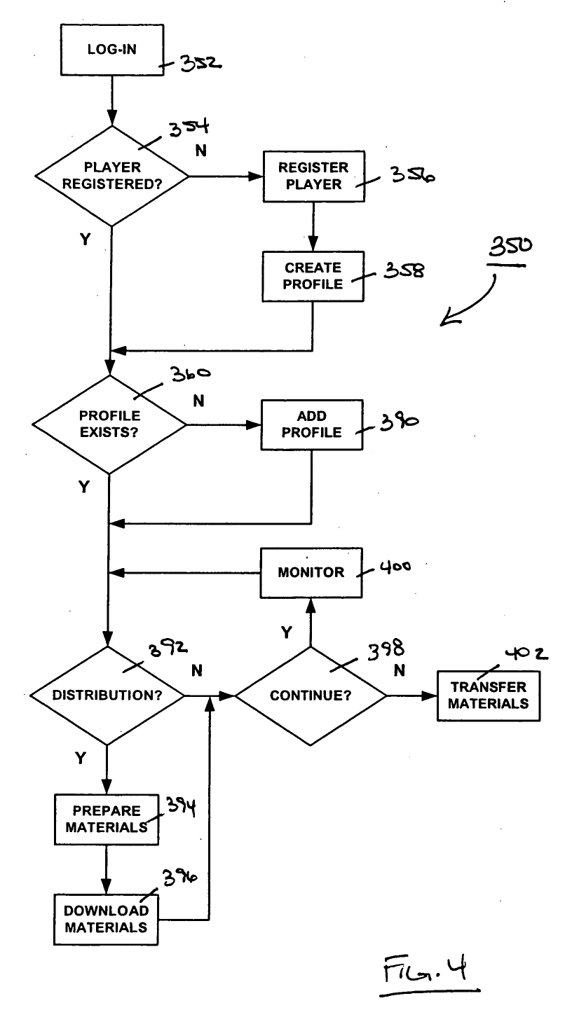

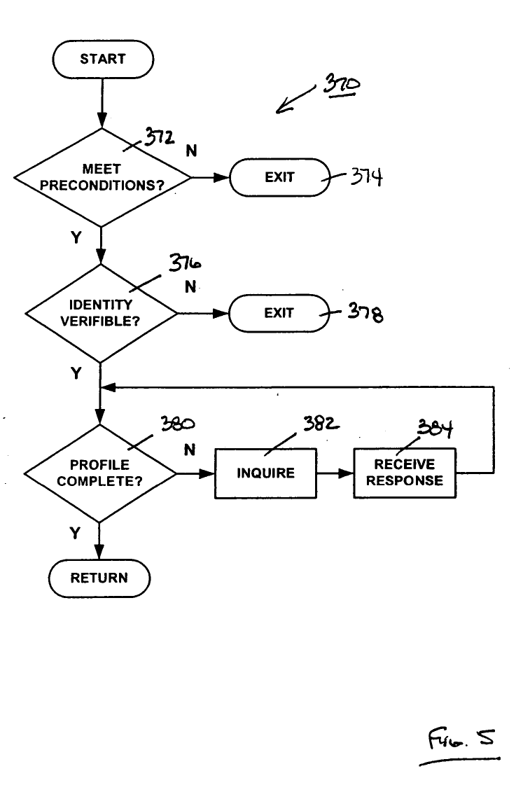

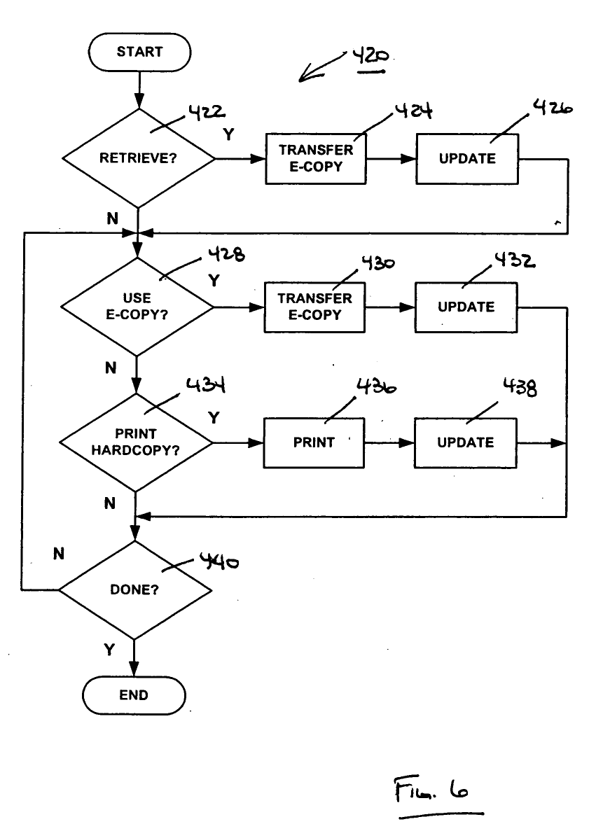

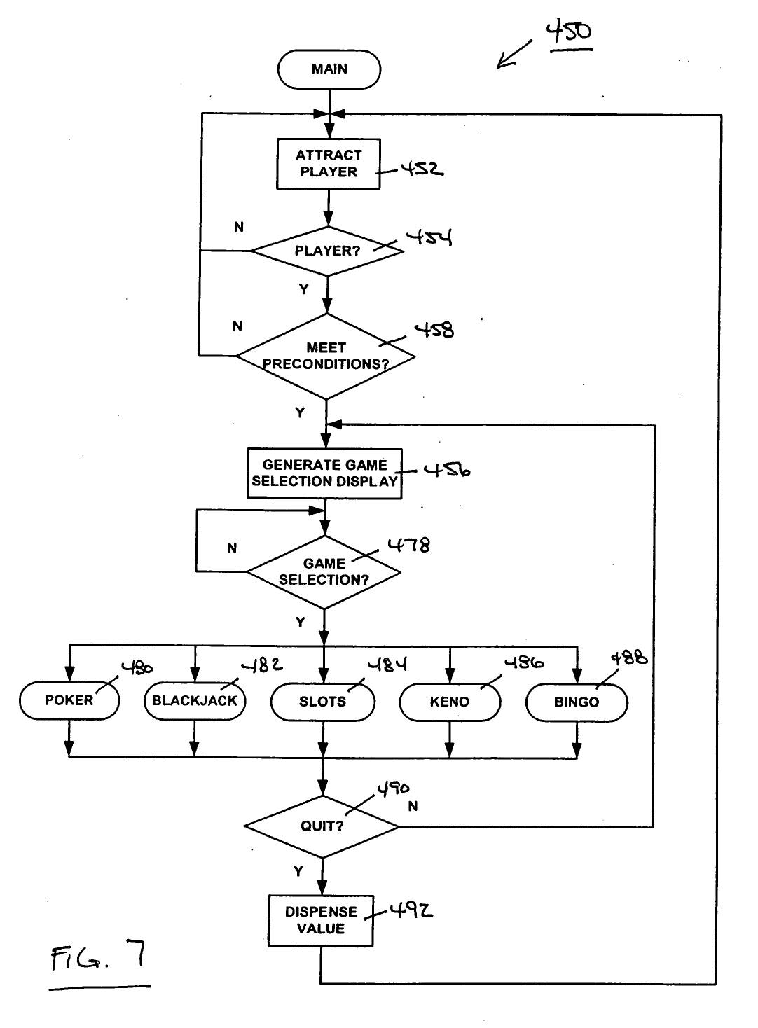

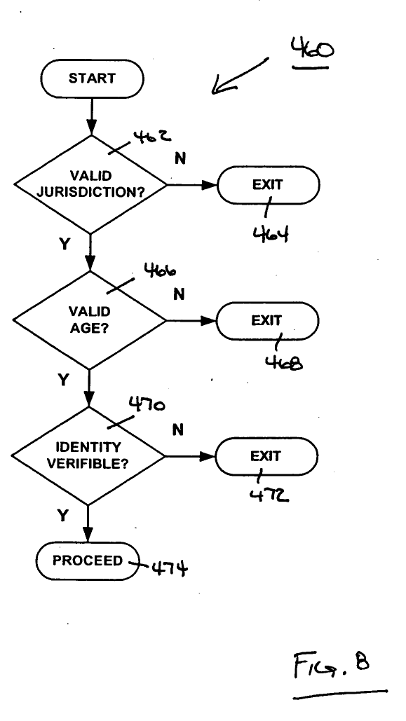

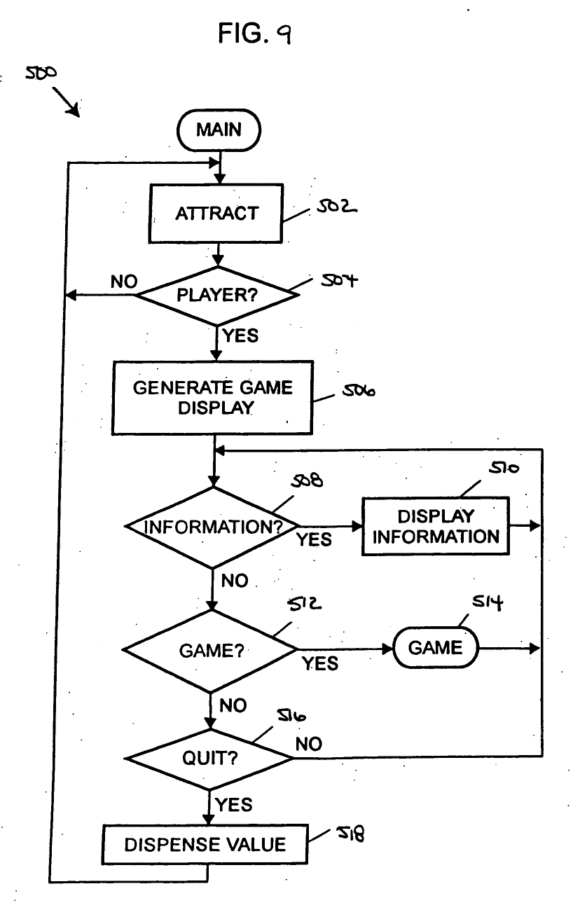

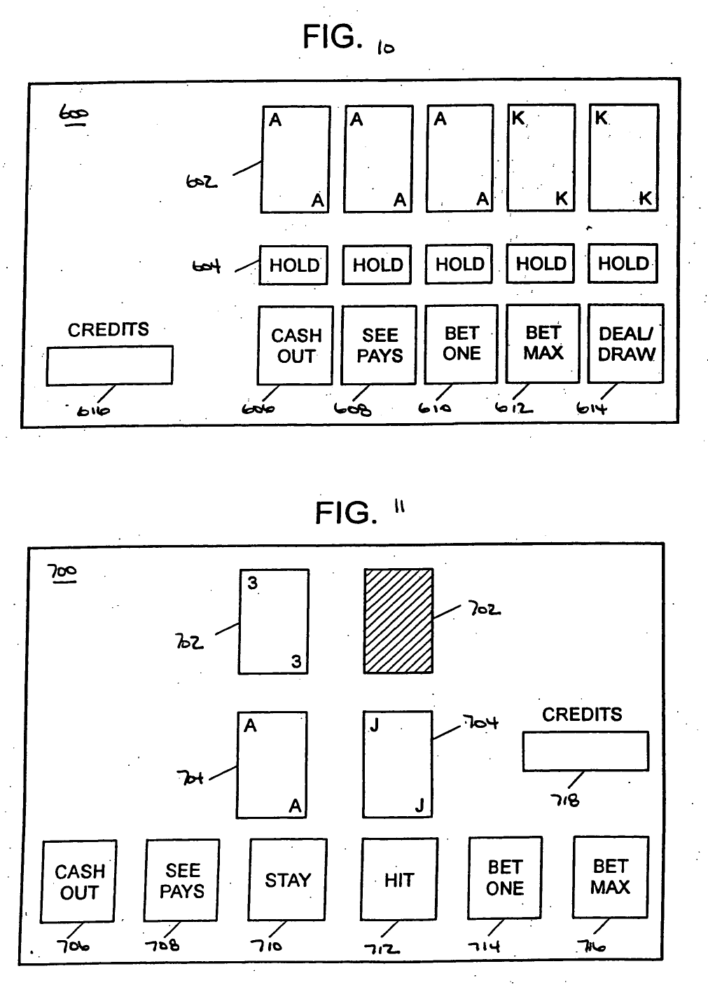

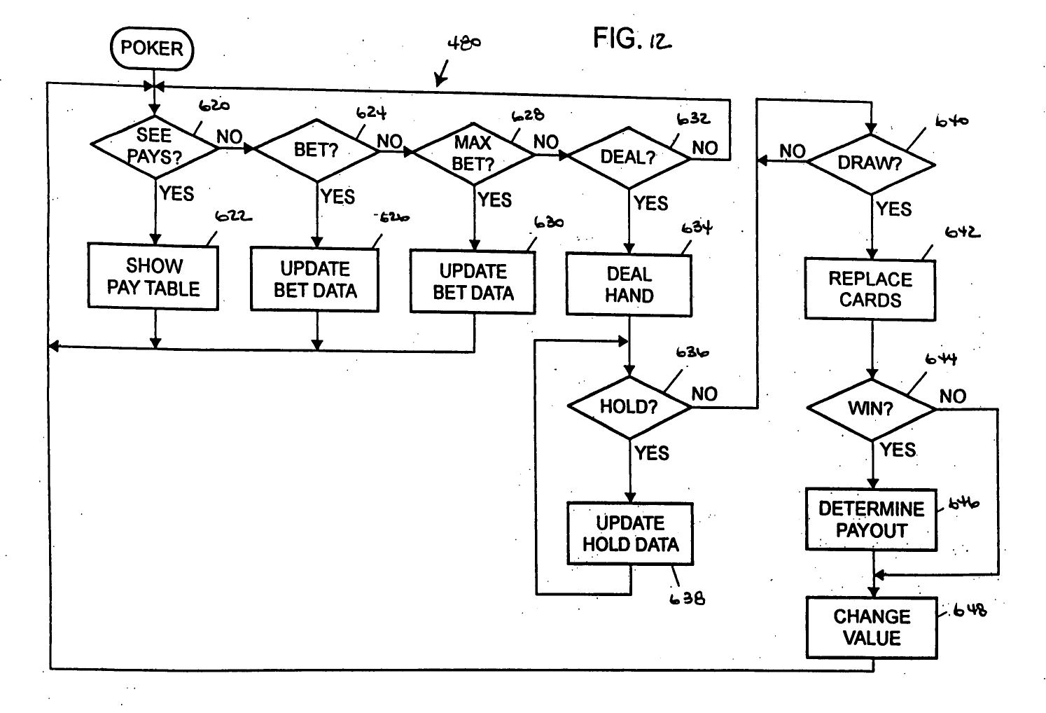

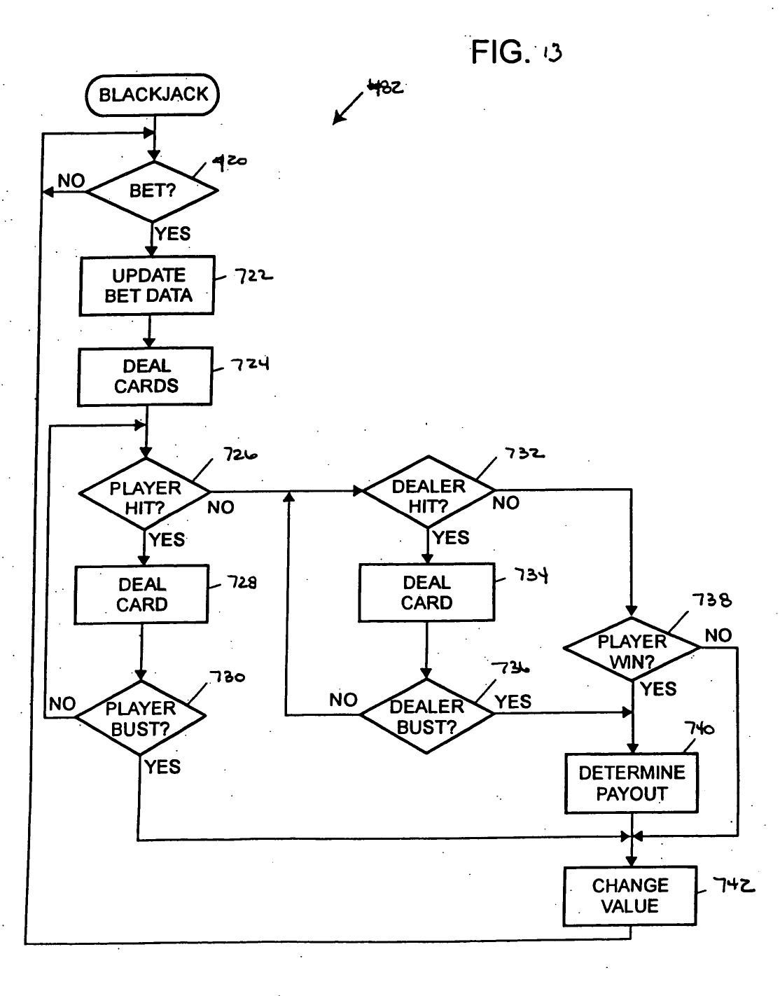

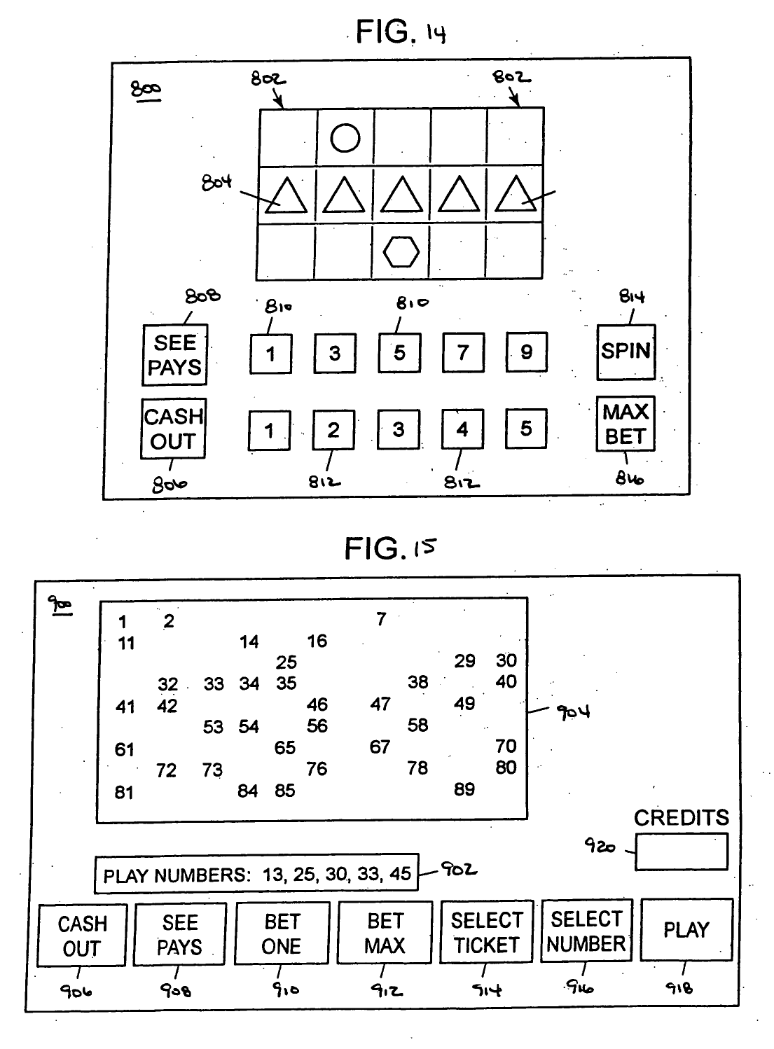

FIG. 4 is a flowchart of a distribution routine 350 that may be stored in the memory of a network computer, such as the e-materials distribution server 130. The routine 350 begins at a block 352 when the server 130 determines that a player is attempting to log-in to the system 50 to access the distribution aspect of the system 50. The player may already be connected to the system 50 via a gaming unit 54, 74, 75, 94, which gaming unit 54, 74, 75, 94 may be located on a casino floor, within a casino property (such as in a casino hotel room) or at a remote location, such as a home. The gaming unit 54, 74, 75, 94 may include a player tracking module 168, although the inclusion of the player tracking module 168 is not a requirement or perquisite. Alternatively, the player may be connected to the system 50 using a personnel communication unit 64 via a wireless communication system including the communications computer 60 and transceiver 62. As a further alternative, the player may be connected to the system 50 using a personnel communication unit 84 via a wireless communication system including the communications computer 80 and the transceivers 82 associated with the gaming units 75. As a still further alternative, the player may be connected to the system 50 using a personal communication unit 122 via a wireless communication system including the communications computer 116 and the transceiver 120. Also, a player may be connected to the system by more than one device, such as is the case where the player may be connected by a gaming unit 54, 74, 57, 94 and a personal communication unit 64, 84, 122.

After the server 130 receives a log-in request from the player, the server determines if the log-in request is associated with a registered player at block 354. Assuming for the moment that the player is not registered, the routine proceeds to block 356 where the player registers and block 358 where the player creates a profile for him or herself. Alternatively, the routine 350 proceeds to block 360.

FIG. 5 illustrates a flowchart describing a routine 370 carried out by the e-materials server relative to the registration of a player with the system 50 and the development of the player's profile. The registration routine may be carried out using devices and personnel of the network operator, or the routine may be carried out using devices of the system 50 but without the assistance of personnel of a network operator. As one example, an employee of the network operator may register players at a specific location set up for this purpose (e.g. at the concierge desk), or may “roam” a casino floor to perform this service wherever the player is located. Alternatively, the player may register him or herself over the Internet, at a kiosk established for registration at the casino (such as the kiosk 88), or at gaming units adapted to permit registration to occur.

Initially, the player is queried at block 372 to determine if the player meets certain preconditions before registration can continue. These preconditions may include information regarding the location of the player at the time the player is accessing the distribution aspect of the system 50, or the location of the player's place of residence. Some jurisdictions may prohibit or limit the use of the distribution aspect of the system 50 described herein, or place certain limitations on the types of people that may use the distribution aspect, particularly in conjunction with the gaming units 54, 74, 75, 94. Thus, the preconditions may also include information regarding characteristics of the player. For example, some jurisdictions may prohibit players of a certain age from using the distribution aspect described herein or from using the distribution aspect described herein in conjunction with the gaming units 54, 74, 75, 94. The player may provide the information concerning him or herself in a variety of manners, depending on the method by which registration is occurring. For example, if the registration is occurring within a casino property and a casino employee is assisting the player in completing registration, some information (such as the location of the player) may be self-evident and other information may be gathered by the casino employee (for example, through the use of a questionnaire). Alternatively, if the registration is occurring at a location remote to the casino property, the player may provide this information by way of an on-line questionnaire that is submitted over a network connection (such as the Internet) to the server 130. As a still further possible precondition, certain types of security measures may need to be implemented before the player can take advantage of the distribution aspect of the system 50; for example, certain level of type of encryption may be required to be use the distribution aspect of the system 50. If the player cannot provided the required information, or if the information shows that the player does not meet the preconditions, the routine exits at block 374 and the player is prevented from registering to use the distribution aspect of the system 50.

Assuming that the information provided at block 370 indicates that the player meets the preconditions, the routine 370 proceeds to a block 376, and the player may be required to verify one or more aspects of the information provided in regard to the information provided at block 372, or to provide additional information that may be used to identify the player in the future, thereby providing an increased likelihood that a person using the player's registration is indeed the player or one of a group of players, where a common registration is used for a group of players. Here as well, if the information is unavailable, if the player refuses to provide the information, or if the verification cannot be completed, the routine exits at block 378.

It should be noted that the block 376 may be optional. That is, according to the regulations of the particular jurisdiction and the policies of the network operator, the information provided at block 372 need not be verified using a source of information separate from the player, but it may. Additionally, the operator may determine that it is not necessary to ensure that a registration is being used by a particular person or one of a particular group of people. In such a circumstance, additional information regarding the identity of the player or players need not be gathered. According to an embodiment, the determination of block 376 may be omitted where the operator can limit access by, for example, underage players to the gaming units 54, 74, 75, 94 (for example, in a casino-type gaming environment as opposed to an Internet-type gaming environment).

However, if required, information verifying the data provided concerning the preconditions at the block 372 may be verified at the block 376. For example, according to an embodiment wherein the player is registering at a casino property and is being assisted by a casino employee, the casino employee may ask the player for a picture identification card to verify that the person providing the information is who he or she is who they say they are, and to verify, for example, age information provided to complete the precondition qualification at block 372. Alternatively, where the player is performing the registration at a site remote to the casino floor, for example in a casino hotel room or at home, the player may need to use, for example, one or more devices coupled to the gaming unit or personal communication unit which they are using to interface with the system 50. As one such embodiment, to verify the location of a gaming unit located off the casino floor or outside the gaming system operator's property, the gaming unit may be associated with a device that provides location data for the gaming unit that may be transmitted to the gaming system operator. For example, the Global Positioning Satellite (GPS) system may be utilized by associating a special transceiver with the gaming unit. As a further example, the gaming system operator may require the player to connect to the system 50 using a cellular mobile station (or at a minimum to make a call using the mobile station or to turn the cellular mobile station on during play). The gaming system operator may then access the location information available to the cellular system operator after the cellular system operator has processed the cellular transmission data from the mobile station (such as may be done in providing enhanced 911 (or E-911) service, for example). Alternatively, the player may be required to connect to the system 50 from a land line (or to call the gaming system operator using a land line telephone during the verification process), whereupon the gaming system operator may check the telephone company's records to verify the number and pull the street address associated with the number. As a further alternative, where the player has connected to the system 50 over the Internet, the gaming system operator may check the IP address of the gaming unit and of the Internet service provider, and obtain a street address from the Internet service provider.

Similarly, the operator may require the player to provide information that will be used at the present time and/or in the future to verify the identity of the player or players associated with a particular registration and/or profile. For example, the player may provide a form of identification (such as a fingerprint or other form of biometric data, driver's license, or national identity card) that the gaming system operator may use to access age data established by a third party (for example, the state department of motor vehicles). As a further alternative, the camera associated with the gaming unit may be used to monitor the player using the gaming unit 54, 74, 75, 94.

Assuming that the preconditions are met at the block 372 and verification is provided, if required, at the block 376, the routine 370 proceeds to block 380, where the determination is made as to whether the profile for the registration is complete.

In this regard, a profile may refer to any collection of information or data that is identified, related or associated with the player being registered. This profile may be stored in a file in a database accessible by the distribution server 130, or it may be stored in the memory of the gaming unit 54, 74, 75, 94 or the personal communication unit 64, 84, 122 used by the player. As a still further alternative, the information may be stored on a player tracking card that may be disposed into the card reader 262 of the player tracking module 260. Further, the profile may include data or information stored remotely to the server 130, which data or information may still remain associated with the profile.

According to one embodiment, the profile may include an identifier. The identifier may be unique to each player, like a cell phone number of the personal communication unit 64, 84, 122 used by the player to interface to the system 50, or may be unique to a group of players relative to the remainder of players registered with the system 50. For example, where the operator intends to distribute the personal communication units to members of a tour group, for example, the desired goal may not be for the distribution aspect of the system 50 to respond differently to each member of the tour group, but rather for the distribution aspect to respond to members of the tour group differently than to the general public. As another example, the gaming system operator may wish to target certain groups or categories of player, e.g., “high-rollers,” to receive bonuses not available to the general public, but available to all the members of the target group. Consequently, the members of the target group may receive personal communication units with an identifier which differentiates the members of the group from the public-at-large and all other players carrying personal communication units. In this regard, some of the personal communication units may develop recognition as a status symbol item as well as performing a practical function.

Moreover, more than one identifier may be assigned to a profile, or stated slightly differently, one profile may be associated with more than one identifier. For example, a particular profile may be associated with a first identifier which indicates that the associated player belongs to a first group, e.g., the “high-roller” group, and with a second identifier which indicates that the associated player belongs to a second group, e.g., the “ultra high-roller” group, which may or may not be exclusive of the first group. Moreover, the second identifier may be unique relative to all other identifiers, such that the associated player may be differentiated from all other players.

The profile may also include one or more records that may contain data about the characteristics, habits and/or preferences of a player associated with the identifier. For example, the profile may include basic personal data that will be stored in a personal data record, including such data as the name, address, Social Security number, date of birth, nationality, language skills, and cultural preferences of the player. The personal data record may also contain important dates, such as birthdays, anniversaries, and other occasions. The profile may also include data regarding the player's favorite foods, shows, prizes, complementaries (“comps”), and the like, this data being stored in an entertainment record and/or a personal prize preferences record. The profile may also include the player's preferences regarding the look of the game displayed, or the types or levels of sensory outputs utilized during the game.

Such records may be created and/or updated manually. That is, the player may enter the data personally, through the use of one or more of the gaming units 54, 74, 75, 94 configured to permit such data entry or via the Internet from a remote location, through the use of a computer that may or may not be configured as a gaming unit. As an alternative, the player may answer questions on a questionnaire, and an employee of the network or system operator may enter the data into the system 50.

Such records may also be created and/or updated by the system 50. For example, the system 50 may generate and maintain a bonus record including a running total of the value wagered by the player and bonuses awarded therefore, and this may be associated with the profile. This information may be obtained, for example, through the use of the player tracking server 132 and associated player tracking modules 168. Extending beyond the monitoring of gaming information, the system 50 may also keep track of information of a player's use of other aspects of an operator's property or properties. Further, the system 50 may generate some of this data by analyzing the movements of the player to restaurants, theaters, etc. This data may then be stored in the entertainment record. Where the player accesses the Internet through the use of the system 50 or where the player permits the operator to track his or her use of the Internet through other methods, the system 50 may establish other records reflecting Internet usage. For example, the system 50 may track the products or services (e.g., travel) purchased by the player over the Internet, or the sites visited or searches run by the player while on the Internet, and store such information in an Internet usage record. As one such example, the system 50 may have relationships with third-parties Internet companies who, with the permission of the player, make the information available to the operator to permit prizes to be selected according to the player's Internet habits. Alternatively, this information may be provided to the operator, with the player's permission, in exchange for providing Internet access via one of the gaming units 54, 74, 75, 94 or personal communication units 64, 84, 122.

Not all information has to come from either the player or the system 50. For example, both the player and the system 50 may generate data about the player's gaming preferences (e.g., favorite casino games) to be stored in a gaming record. Similarly, both the player and the system may generate (through data analysis) data about the player's wagering preferences to be stored in a wagering record. This data may include whether the player prefers to always bet the maximum, to always bet the maximum on certain games, to always bet a certain amount on certain value games, etc.

According to another embodiment, however, a profile may be prepared including only an identifier, or an identifier and associated records containing no information that would identify the registration with a unique individual. Such a registration may be referred to as an anonymous registration. Where only an identifier is used, the identifier may be used merely for tracking the number of participants in the distribution aspect of the system 50, and, perhaps, to permit the storage of the e-materials distributed to the anonymous player in a location on the system 50 (for example, in a database associated with the server 130). According to another embodiment, however, the anonymous registration may have a profile associated therewith, the profile containing some information concerning the characteristics of the associated player, but lacking other characteristics that would particularly identify the player associated with the anonymous registration. For example, the profile may include information regarding the players association with a particular group of players (for example, female players, players over age 60, players belonging to a particular tour group, etc.), but not information that would particularly identify the player registering (for example, name, address, Social Security number, date of birth, etc.). According to either embodiment, the identifier used may be an alias, either for the individual player or for the group of which the player is a member.

The profile may be complete, or ready to upload to the system, upon the completion of the screening blocks (blocks 372, 376). That is, the information that may make up the player's profile for the distribution aspect of the system 50 may also be required for other aspects of the system 50, such as a bonusing aspect or a player tracking aspect, and upon completion of the screening blocks (block 372, 376) the system 50 may assemble the profile without further input from the player. According to other embodiments, it may be necessary to ask the player for additional information at the time of registration. If required, the routine may proceed through blocks 382, 384 as necessary to gather the information necessary to complete the player's profile. When the profile is complete, the routine returns to block 360 of routine 350 in FIG. 4.

At block 360, the server 130 may determine if the profile associated with the registered player has been stored in a database associated with the server 130. That is, the server 130 may not maintain profiles for all registered players within the associated database. For example, to limit the amount of storage space required for the profile database associated with the server 130, only profiles of players presently utilizing the distribution aspect of the system 50 may be stored in the associated database. Between uses of the distribution aspect of the system 50, the player's profile may be stored in a different location. This other storage location may be the personal communication unit 64, 84, 122 associated with the player, the gaming unit 54, 74, 75, 94, or a storage device or computer (such as the network computers 56, 76, 110) associated with the remainder of the system 50. The storage location may even be a smart card, which may be read by the card reader 262 associated with the player tracking module 260. Where the server 130 does not maintain a complete associated database of all profiles of all registered players, the server 130 may need to load the player's profile into the associated profile database when a player logs in to the distribution aspect of the system 50. If the server 130 determines at block 360 that the profile is not presently stored in the associated profile database, the profile is retrieved from its storage location and added to the database at a block 390. Alternatively, if the server 130 maintains a profile database for all registered players, this block may be omitted.

At the block 392, a determination may be made whether there are e-materials to be distributed to the player. If the determination is made that there are e-materials to be distributed, then the routine 350 proceeds to blocks 394, 396, where the e-materials are prepared for download and the e-materials are downloaded. Otherwise, the routine 350 proceeds to block 398.

The determination to distribute the e-materials may be made by the server 130. Alternatively, the determination to distribute e-materials may be made in response to an inquiry from the registered player, or, more particularly, from the gaming unit 54, 74, 75, 94 or personal communication unit 64, 84, 122 associated with the player.

According to the first alternative, the server 130 may determine to distribute the e-materials to one or more players according to some criterion determined by the system operator and/or at a time determined by the system operator. For example, the system operator may determine that a particular outcome on one or more of the gaming units 54, 74, 75, 94 may trigger a distribution of the e-materials. This outcome may be as part of a primary game, bonus or secondary game, or tournament game. As another example, the system operator may determine that a particular e-material will be distributed once a player or group of players have played a certain number of games, wagered a certain amount of value, or received a certain amount of value in payouts (as monitored in a data record associated with the player's identifier). This distribution determination may be made according to information received from the player tracking system (player tracking server 132 and player tracking modules 168). As still another example, the distribution may occur when a player receives a certain number or achieves a certain level of player tracking points or bonus points. As yet another example, the system operator may determine that a particular e-material will be distributed to players having ascertain profile at a certain time of the day (e.g. dinner time), week (e.g., Monday, which may be a less profitable, or slow, day), month or year, or will be distributed to all registered players or to all anonymous players at a certain time of the day, week, month or year. This distribution determination may be made as part of a promotional or targeted marketing effort, and may include a distribution not only to players physically located in an associated casino property during a gaming session or otherwise, but also to those registered players that are connected to the system 50 through a mobile communications network, such as that provided by the communications computer 116, transceiver 120, personal communication unit 122, and data link 124, that may be outside of such a casino property. The distribution may occur at any given time.

According to the second alternative, the gaming unit 54, 74, 75, 94 or personal communication device 64, 84, 122 may send a message to the server 130 providing the associated player's registration number, and requesting any e-materials that might be available for that player. The sending of the message may be triggered by some of the same kinds of conditions referred to above that would trigger the server 130 to determine that a distribution should be made; for example, the request may be sent at a particular time of the day, month or year. The message may also be sent should the player wish to exchange a certain number of points assigned to the player as a consequence of a player tracking (to reflect wagers received from the player, for example) or bonusing system (to reflect winning outcomes associated with the player, for example); in such a case, the a total player tracking points or total bonusing points would be updated (reduced) to reflect the redemption of the points. As an alternative, the message may be sent at certain times through out the day, periodically or aperiodically.

The e-materials which may be, according to one embodiment, an electronic instrument which may be referred to herein as an electronic coupon, or an e-coupon. The e-coupons may be redeemable at one of the gaming units 54, 74, 75, 94 for free game play. Alternatively, the e-coupon may be redeemable at one of the gaming units 54, 74, 75, 94 for a modification of the game play provided by one or more of the gaming units 54, 74, 75, 94. That is, the e-coupon may be redeemable, for example, for an enhancement to the operation of the gaming unit 54, 74, 75, 94, such as a multiplier for the payout of a primary or a bonus game. The e-coupons may be redeemable for a payout in the form of goods or services provided by the casino operator, which operator may also provide other amenities besides the operation of the gaming units 54, 74, 75, 94. For example, the gaming units 54, 74, 75, 94 may be disposed in one or more casino properties, which properties may provide not only gaming services, but food and lodging, entertainment services, goods, etc. According to such an embodiment, the e-coupons may be for free or reduced price gaming, food, drinks, lodging, entertainment, goods, etc. According to another embodiment, the casino operator may provide on-line services, such as on-line gaming, in which case the e-coupons may be for free or reduced price on-line gaming. As still a further embodiment, the e-coupons may be for the goods or services of third-party vendors that may have a relationship with the casino operator. According to this embodiment, the e-coupons may be prepared by the casino operator, may be provided by the third-party vendor to the casino operator, or may be provided by a separate party who acts as an intermediary between the third-party vendor and the casino operator in regard to the preparation of the e-coupons.

It will also be recognized that the e-coupon may be stored on a machine accessible medium. As indicated above, a machine accessible medium includes any mechanism that provides (i.e., stores and/or transmits) information in a form accessible by a machine (e.g., a computer, network device, personal digital assistant, any device with a set of one or more processors, etc.). As stated previously, a machine accessible medium includes, for example, recordable/non-recordable magnetic, optical and solid-state media (e.g., read only memory (ROM), programmable read only memory (PROM), erasable programmable read only memory (EPROM), electrically erasable programmable read only memory (EEPROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. According to the present embodiment, the machine accessible medium may include the memories associated with the servers 130-142, the memories 312, 316 of the controllers 310 of the gaming units 54, 74, 75, 94, or the personal communication units 64, 84, 122.

The e-coupons may include information such as the identifier associated the player's profile, another identifier (such as a serial number), authorization code;, expiration date, identification of the goods and/or services that are related to the e-coupon, identification of a location at which or medium (electronic, hardcopy, etc.) in which the e-coupon must be redeemed, identification of a sponsor related to the e-coupon, identification of the value of the e-coupon (such as in terms of a currency basis or on a percentage basis), etc. In the alternative, the e-coupon may not provide such information to the player at the time the e-coupon is distributed to the player. Such information may only be visible to or accessible by the player at the time the e-coupon is downloaded to a personal communication unit 64, 84, 122, at the time the e-coupon is redeemed, or in conjunction with some other activity of the player.

For example, the other information or data associated with the e-coupon may only be visible to or accessible by the player if the player participates in a particular tournament, or plays one of a select set or group of gaming units 54, 74, 75, 94 at a particular time of day. Alternatively, the player may have to travel to a particular location within a casino, or may have to travel to a related casino property. In this sense, the activation of the e-coupon may take on the appearance of a treasure hunt, in that the player may be required to travel to various points in a casino property and perform certain actions (such as playing one of the gaming units 54, 74, 75, 94 a particular number of times or participating in a particular tournament) before the information or data associated with the e-coupon may be accessed. As a further alternative, the player may have to visit a particular website before the data associated with the e-coupon is visible or accessible. The activities of the player may be tracked through the use of the player tracking system (player tracking server 132 and related units 168) or the Internet server 142, for example.

As another example, the information associated with the e-coupon may vary over time, or in conjunction or association with the activity of the player. That is, the e-coupon distributed to the player may include an identifier, which may be associated with an entry provided, for example, in a database maintained by the operator, and in particular, in conjunction with the e-coupon distribution server 130. In this sense, the e-coupon may be viewed similar to a key to a chest or a door to a room, and may be in the form of a “cookie” that can be downloaded to a particular gaming unit 54, 74, 75, 94 or personal communication unit 64, 84, 122. Depending on the activity of the player, for example, as reflected by data downloaded from the player tracking server 132 to the e-materials distribution server 130, the e-distribution server 130 may vary other terms of the e-coupon stored as the entry in the database associated with the identifier of the e-coupon.

Thus, if the player were to download the data associated with the identifier of the e-coupon from the e-materials distribution server at a first time (for example, after the player receives a first winning combination), the data may indicate that the e-coupon is redeemable for five free $1 plays, and at a second time (for example, after the player receives a second winning combination), the data may indicate that the e-coupon is for ten free $1 plays. Similarly, at a third time (for example, on the day associated with the player's birthday), the data may indicate that the e-coupon is redeemable for a particular good (e.g., a leather jacket) provided by a third-party vendor, who may also sponsor such a prize, either at the third-party vendor's retail establishment or via a website. Thus, depending on when the player chooses to download the data in the entry corresponding to the identifier of the e-coupon and/or the events associated with the player, the player would receive a different payout.

Also, if the player were to download the data associated with the identifier of the e-coupon at dinner time, for example, the coupon may be redeemable for a food item. Alternatively, if the player were to download the data on Saturday night, the coupon may be redeemable for tickets to a show. By contrast, if the player were to download the data on a slow Monday night, the coupon may be redeemable for a multiplier to be used on one of more payouts awarded at a gaming unit, for example.

Similarly, the location of the download may be the determining factor as to which payout was associated with a particular e-coupon. If the e-coupon is redeemed with the casino operator at one of the networks 52, 72, 92, the identifier associated with the e-coupon may permit the player to redeem the e-coupon for five free $1 plays. If the e-coupon is redeemed with the casino operator at a casino property associated with the networks 52, 72, 92, such as a hotel or restaurant, the e-coupon might be redeemable for a beverage or a certain percentage discount on a room. Further, if the e-coupon is redeemed with a third party, such as a clothing retailer, the e-coupon might have a value of $5.00. Thus, depending or where or with whom the player chooses to redeem the e-coupon, the player may receive a different payout.

As a still further alternative, the data associated with the e-coupon may vary according to the form in which the e-coupon is redeemed. For example, if the e-coupon is redeemed in electronic form, a different value may be associated with the coupon than if the coupon is redeemed after being printed out in hardcopy. The difference in redemption value may be caused by a difference in the cost of administering the redemption process if the coupon is used in electronic form, which may assist in automating the accounting and record-keeping operations of the distribution aspect of the system 50, as opposed to in hard copy. The redemption value may be adjusted to cover the costs of providing a hard copy of the e-coupon to the player. Thus, depending in what form the player chooses to redeem the e-coupon, the player may receive a different value.

It will be recognized that the data associated with the e-coupon may, in fact, be determined according to more than one of the variables discussed previously. That is, the time at which the e-coupon is downloaded, the events associated with the player, the location of the redemption, the party with which the player attempts to redeem the coupon and the form in which the e-coupon is redeemed, along with other factors, may, individually or in combination, affect the data associated with the e-coupon. As one such example, the various parties and entities with which the player may redeem the e-coupon may vary the awards associated with a particular e-coupon according to whether the player attempts to redeem the coupon on his or her birthday. As another example, the various parties or entities may vary the data associated with (and, thus, the award associated with) the e-coupon according to one or more of the records associated with the player's profile, where the player has established a profile, or according to the absence of such records, where the player has remained anonymous.

All of the potential variables which may influence the characteristics of the e-coupon may be stored, for example, such as in the server 130, although that need not be the case. The server 130 may provide only a “clearinghouse” function, whereby the e-coupons are tracked as they are distributed and identify the relative value that should be associated with the e-coupon. The individual third party vendors (or sponsors) or their e-coupon providers may then solicit information from the network operator (for example, in the form of the profile associated with a player, where permitted by the player) and make their decisions independently as to how to administer the balance of considerations involved in associating a specific redemption good or services, for instance, with the e-coupon. According to such an embodiment, the network operator may recognize a reduction in the overhead necessary to maintain the distribution aspect of the system 50, considering that the third parties (or their appointed representatives) would be responsible for sharing the determination of which goods, services or other value are associated with the e-coupons. The network operator may also recognize a reduction in the bandwidth required to transfer information regarding the e-coupons distributed to the participating third-party vendors, as the vendors or their representatives would be responsible for associating the payout provided at their end, rather than the network operator being responsible for making the selection and transmitting the information or data associated with the selection to the third-party vendors or their representatives.

The changing, or “morphing,” nature of the e-coupon may be known to the player, for example, by virtue of information materials provided to the player by the network operator. Alternatively, the player may discover this nature of the e-coupon over time, such as in the instance where the player downloads an e-coupon after a particular set of trigger events has occurred and then downloads an e-coupon after a similar set of trigger events has occurred plus an additional trigger event has occurred. As a further alternative, the changing nature of the e-coupon may remain unknown to the player entirely.

It should also be recognized that the information associated with the e-coupon may have more than a figurative relationship with the key-lock analogy. The information associated with the e-coupon may, in fact, be a password that permits the player to access a good or service that others without the password cannot access. For example, the password may permit the player access to a secured website, which site may host services such as music downloads, telephony services, etc. According to this embodiment as well, one password may permit access to a variety of websites, the goods or services provided at each of the websites (alternatively, the access) varying according to the password provided by the player as determined by the associated e-coupon.

Other e-materials may be distributed in conjunction with the e-coupon, the distribution of such materials being contemporaneous with the distribution of the e-coupon, preceding the distribution of the e-coupon, or after the distribution (and even after the redemption of) the e-coupon. For example, advertising materials may be provided in conjunction or association with the e-coupon. These advertising materials may include text, pictures, photographs, multimedia materials, hypertext links, etc. The advertising materials may be provided to form a connection between the player and the casino operator, between the player and the party providing the good or service (i.e., the sponsor), or between the good and/or service received and some characteristic of the good and/or service to be received. As a further alternative, the advertising material may be for the purpose of informing the player of the features of the good and/or service for which the e-coupon may be redeemed.

The preparing of the materials for download at the block 394 may include downloading the e-materials from or to one or more computers other than the server 130. For example, where the e-materials are provided by a third-party vendor or a third-party intermediary, the e-materials may need to be downloaded from a remote server. Moreover, the e-materials may be downloaded to an intermediary server, such as the gaming machine download server 134, the remote access server 138, the offsite intranet server 140, and/or the Internet server 142. Additionally, the preparation at the block 394 may include formatting the e-coupon, for example, where the e-coupon is in the form of a cookie, prior to downloading the e-coupon in the block 396. The preparation may also include the formatting of the e-coupon to ensure the integrity and security of the e-coupon, for example through the use of cyclic redundancy checks and encryption techniques.

In fact, the downloading of the materials at block 396 may not be a direct download of materials from the server 130 to a storage device associated with a player, such as a network computer 56, 76, gaming unit 54, 74, 75, 94, or personal communication unit 64, 84, 122. In fact, according to one embodiment of the system 50, the e-materials to be distributed may be stored in a variety of locations, such as the gaming machine download server 134, the remote access server 138, the offsite intranet server 140, and/or the Internet server 142. Rather than downloading the e-materials to the player via the system 50, the server 130 may provide a command, or event, that is then communicated to all of the servers in the system 50. In response to the event, the individual servers determine if the event has significance for them, and, if so, what the significance might be. For example, the server may send a particular event that causes a download of e-materials from the gaming unit download server 134, but which the remote access server 138, the intranet server 140 and the Internet server 142 may ignore. This event may be associated with a particular promotional that has been prepared to encourage the use of the gaming units 172 associated with the gaming unit download server 142 at a particular time of day when the gaming units 172 may not otherwise be operated or when the identifier of gaming units 172 in operation falls below a certain level. In the alternative, the server may send a particular event that causes a download to occur from the gaming unit download server 134, the intranet server 140 and the Internet server 142 at approximately the same time (for example, a holiday). However, even if the servers 134, 140, 142 are generally synchronized as to the time of the distribution of the e-materials according to the event sent, the servers 134, 140, 142 may download different e-materials. The gaming unit download server 134 may download e-coupons redeemable at the casino property, the offsite intranet server 140 may download e-coupons redeemable at other properties, and the Internet server may download e-coupons redeemable for on-line gaming or at on-line vendor sites.

Moreover, while the distribution aspect of the system 50 may coordinate with the gaming aspect of the system 50, the two aspects may operate independent of each other. That is, where a determination is made at block 392 that a distribution should be made and at block 396 that the materials to be distributed should be downloaded to a gaming unit 54, 74, 75, 94 on which a player is presently playing a game, the distribution aspect of the system may delay the download of the materials to the gaming unit 54, 74, 75, 94 where the download of the materials would interrupt the game presently being played, or the player's concentration, or both. On the other hand, the distribution aspect of the system 50 may operate without the player operating one of the gaming units 54, 74, 75, 94. For example, the server 110 may determine that materials are to be distributed to a registered player that is logged in to the distribution aspect of the system 50 even if the player is not presently operating one of the gaming units 54, 74, 75, 94. For example, the player may log in to the distribution aspect of the system 50 while in his or her hotel room before going to the casino to download any e-coupons that may be redeemable for game play, perhaps in response to a message that is broadcast by the casino operator using the television system available in the player's hotel room.

At the block 398, the determination may be made if the player wishes to continue use of the distribution system. If the player wishes to continue use of the distribution system, the routine 350 passes to a block 400, wherein the server 130 continues to monitor the players' activities. The server 130 may be monitoring the performance of the player as the player interacts with the gaming aspects of the system 50, perhaps making use of the player tracking server 132 and associated player tracking modules 168. The server 130 may be monitoring the system 50 to determine if the gaming unit 54, 74, 75, 94 or personal communication device 64, 84, 122 associated with the player have made a request for an update as to distribution. If the determination is made at the block 392 that a distribution is to be made, then the routine proceeds to the blocks 394, 396; if the determination is made at the block 392 that no distribution is to be made, then the routine proceeds to the block 398, and as long as the player wishes to continue, the loop of blocks 392, 398, 400 continues.

In fact, according to one embodiment of the distribution aspect of the system 50, the monitoring of the players' activities at block 400 includes monitoring not only the players' gaming performance, but also the players' activities within the casino property that are not related to gaming. For example, a sensor array 190 may be associated with the system 50 and operatively coupled to the server 110, as illustrated in FIG. 1A. The sensors of the sensor array 190 may be similar to the transceivers 64, 84, 120 illustrated in FIG. 1, in that the sensors are capable of forming a link with a personal communication device 64, 84, 122 associated with a player that is registered and logged in to use the distribution aspect of the system 50. As the player moves from location to location within a casino property, the communication links formed between a personal communication unit 64, 84, 122 associated with the player and the sensors 190 may permit the distribution aspect of the system 50, and in particular the server 110, to monitor the location of a player and thus monitor (albeit indirectly) the players use of the casino property other than the gaming units 54, 74, 75, 94. Alternatively, the player's use of other parts of the casino property may be determined by coupling, for example, the accounting system used for an associated restaurant or hotel to the server 110.

At some point, the player may desire to discontinue participation in the distribution aspect of the system 50. This discontinuation may come at the same time as the player wishes to discontinue use of the system 50 entirely, although that need not be the case; the player may continue to participate in the gaming aspect of the system 50, for instance. If the determination is made at the block 398 that the player wishes to discontinue participation in the distribution aspect of the system 50, then the routine 350 proceeds to a block 402, where the e-materials may be transferred to a storage location of the player's choosing, if this has not already been done. For example, the server 130 may send an event, based on the player's profile, etc., that may cause an e-coupon to be downloaded to the gaming unit 75 associated with the player. The player may decide to upload the e-coupon downloaded to the gaming unit 75 to his or her player account. However, as the gaming unit 75 has a transceiver 82 associated therewith, where the player has a personal communication unit 84, the player may elect to further download the e-coupon from the gaming unit 75 to his or her personal communication unit 84. As a still further alternative, the server 130 may initially store e-coupons for a player participating in the distribution aspect of the system 50 in association with the player's player tracking account on the player tracking server 132. In such a case, the player may wish to transfer the e-coupons from the player tracking server 132 to a personal communication unit, such as the unit 122, and may used the communication system including the communications computer 116 and transceiver 122 to do so.

### Redemption Routine

FIG. 6 is a flowchart of a redemption routine 420 that may be used in conjunction with the system 50, in whole or in part. The redemption routine 420 is only one such routine that may be used in conjunction with the system 50 and e-materials described above. For example, certain e-materials may be redeemed immediately upon distribution, such as may be the case when an e-coupon for free game time is distributed to a player that is presently using the gaming aspect of the system 50 to play a game, a slots game for instance. According to such an embodiment, the player may not even be required to confirm redemption of the e-coupon, and redemption may occur with only a message signaling to the player that an e-coupon has been distributed and redeemed.

The routine 420 may begin at a block 422, wherein a determination is made if the player, who now desires to redeem e-materials, such as e-coupons that have been distributed to the player, needs or desires to upload or download the e-coupons. That is, while the player may have previously been afforded an opportunity to transfer the e-materials at the block 408 of the main distribution routine 350, the player may have elected to delay transfer of the e-coupons until such time as he or she desires to redeem the e-coupons. If the player needs or desires to upload or download the e-coupons, the routine 420 proceeds to a block 424, wherein the e-coupons (in the form of electronic copies) are transferred, and to a block 426, wherein the location from which the e-coupons were transferred is updated to reflect that the e-coupons have been transferred. As one example, the e-coupon may be redeemable for game play at one of the gaming units 75, and the e-coupon may be uploaded from a personal communication unit 84 using the transceiver 82 associated with the gaming unit 75, which transceiver 82 may be an infrared transceiver and which personal communication unit 84 may be a PDA.

At a block 428, the determination may be made as to whether the player is using the e-coupon in electronic form. For instance, the player may be seeking to transfer the e-coupon to a third-party vendor as full or partial payment for a good or service selected from the vendor's site. Alternatively, the player may be seeking to transfer the e-coupon to the network operator in exchange for a service provided on-line, for example additional game play. If the player wishes to use the e-coupon in electronic form, then the routine 420 continues to blocks 430, 432, wherein the electronic copy of the e-coupon is transferred to the appropriate party and the location from which the e-coupon is transferred is updated to reflect that the e-coupon had been transferred.

Alternatively, or in addition to (if the player has more than one e-coupon), a determination may be made as to whether the player wishes to print out a hard copy of the e-coupon at a block 434. In an embodiment where the e-coupon is redeemable at the casino property for goods and/or services or is redeemable with a third-party vendor that operates retail stores that a player may visit, the player may prefer to print out a copy of the e-coupon to be used in lieu of an electronic copy of the e-coupon. In fact, the system 50 may include one or more kiosks 88 which may be established for the purpose of providing a point of access to the system 50 for a player that has received e-coupons from the distribution aspect of the system 50, and the kiosks 88 may be equipped with a printer to permit the player to retrieve his or her e-coupons and print them out at the kiosk 88. As a further alternative, one or more of the gaming units 54, 74, 75, 94 may have a printer associated therewith, and permit the player to retrieve and to print out the e-coupons thereat. If the player elects to have the e-coupon printed out in hard copy, then routine may proceed to a block 436 wherein the e-coupon is printed out. Optionally, the location where the e-coupon is stored may be updated at block 438 to reflect that the player printed out the coupon for use; however, where the e-coupon is capable of being redeemed more than once or where the e-coupon may be printed out multiple times before it is redeemed for a good and/or a service, then the storage device may not be updated.

At a block 440, the routine 420 determines if the player wishes to complete his or her use of the redemption aspect of the system 50, or if the player has no additional e-coupons to redeem. If so, then the routine 420 ends; if not, then the routine returns to the block 428, and repeats the determinations 428, 434, 440 until such time as the determination is made at block 440 that the player is done (wishes to end the routine or has no additional e-coupons to redeem).

### Main Gaming Routine

FIG. 7 is a flowchart of a gaming main operating routine 450 that may be stored in the memory of the controller 310. Referring to FIG. 7, the main routine 450 may begin operation at block 452 during which an attraction sequence may be performed in an attempt to induce a potential player in a casino to play the gaming unit 54. The attraction sequence may be performed by displaying one or more video images on the display unit 274 (if provided as a video display unit) and/or causing one or more sound segments, such as voice or music, to be generated via the speakers 270. The attraction sequence may include a scrolling list of games that may be played on the gaming unit 54 and/or video images of various games being played, such as video poker, video blackjack, video slots, video keno, video bingo, etc.

During performance of the attraction sequence, if a potential player makes any input to the gaming unit 54 as determined at block 454, the attraction sequence may be terminated. The gaming unit 54 may detect an input at block 454 in various ways. For example, the gaming unit 54 could detect if the player presses any button on the gaming unit 54; the gaming unit 54 could determine if the player deposited one or more coins into the gaming unit 54; the gaming unit 54 could determine if player deposited paper currency into the gaming unit; etc.

After terminating the attraction sequence, the routine 450 may proceed to a block 456, and a game-selection display may be generated on the display unit 274 (if provided as a video display unit) to allow the player to select a game available on the gaming unit 54. However, according to certain embodiments of the system 50, the gaming units may be provided at locations remote from the place of business of the operator of the system 50 (for example, as illustrated by the gaming units 184, 186 in FIG. 1A, which gaming units are coupled to the remainder of the system 50 via the Internet 164). In such a situation, it may be necessary to ensure that certain preconditions are met before the player is permitted to place a wager and play a game. A block 458 is shown in FIG. 7, and represents a determination as to whether a player has met the preconditions for placing a wager and playing a game. The determination represented by the block 458 in FIG. 7 may be discussed in greater detail with reference to a verification routine 460 in FIG. 8.

According to FIG. 8, the verification routine 460 begins at a block 462, wherein a determination may be made at to whether the gaming unit (e.g., gaming unit 184) is located in a jurisdiction that permits gaming. This determination may be made by referring to the same types of information as was discussed above with reference to the block 376 of the routine 370 shown in FIG. 5. If the determination is made that the gaming unit is not located in a jurisdiction that permits gaming, the routine exits at a block 464, and the routine 450 returns to the block 452; otherwise, routine passes to a block 466.

At the block 466, a determination may be made as to whether the player meets minimum age requirements (set by state gaming agencies, for example) necessary to operate the gaming unit. For example, a registration event at the gaming system operator's place of business, the player may provide proof of age and identity. The data may then be stored in a memory, such as a server operating as a database at the gaming system operator's place of business or a more portable memory device, such as a memory card or a PDA. The age data may be accessed later to prove age qualification by matching (within established standards) the identity data stored with the age data. If the determination is made and the player fails to age qualify, then the routine 460 may exit at block 468, and the routine 450 returns to the block 452; if the player age qualifies or the determination is omitted, then the routine proceeds to block 470.

At the block 470, a determination may be made as to whether the identify of the player can be verified. The determination of block 470 may be omitted where the gaming system operator can limit access by underage players to the gaming units (for example, in a casino-type gaming environment as opposed to an Internet-type gaming environment). However, the system operator may require that the player provide a form of identification (such as a fingerprint or other form of biometric data, driver's license, or national identity card) that the gaming system operator may use to access age data established by a third party (for example, the state department of motor vehicles). As an alternative, a camera associated with the gaming unit may be used to monitor the player using the gaming unit to verify identity. If the player fails to provide or is unwilling to provide proper verification of identify, the routine 470 exists at a block 472 and the routine 450 returns to the block 452; alternatively, the routine 460 passes to a block 474, and the routine 450 passes to the block 456.

The game-selection display generated at block 456 may include, for example, a list of video games that may be played on the gaming unit 54 and/or a visual message to prompt the player to deposit value into the gaming unit 54. While the game-selection display is generated, the gaming unit 54 may wait for the player to make a game selection. Upon selection of one of the games by the player as determined at block 478, the controller 310 may cause one of a number of game routines to be performed to allow the selected game to be played. For example, the game routines could include a video poker routine 480, a video blackjack routine 482, a slots routine 484, a video keno routine 486, and a video bingo routine 488. At block 478, if no game selection is made within a given period of time, the operation may branch back to block 452.

After one of the routines 480, 482, 484, 486, 488 has been performed to allow the player to play one of the games, block 490 may be utilized to determine whether the player wishes to terminate play on the gaming unit 54 or to select another game. If the player wishes to stop playing the gaming unit 54, which wish may be expressed, for example, by selecting a “Cash Out” button, the controller 310 may dispense value to the player at block 492 based on the outcome of the game(s) played by the player. The operation may then return to block 452. If the player did not wish to quit as determined at block 490, the routine may return to block 456 where the game-selection display may again be generated to allow the player to select another game.

It should be noted that although five gaming routines are shown in FIG. 7, a different number of routines could be included to allow play of a different number of games. The gaming unit 54 may also be programmed to allow play of different games.

FIG. 9 is a flowchart of an alternative main operating routine 500 that may be stored in the memory of the controller 310. The main routine 500 may be utilized for gaming units 54 that are designed to allow play of only a single game or single type of game, and does not include the preconditions block shown in the routine of FIG. 7, although the routine of FIG. 9 may be altered to include such block. Referring to FIG. 9, the main routine 500 may begin operation at block 502 during which an attraction sequence may be performed in an attempt to induce a potential player in a casino to play the gaming unit 54. The attraction sequence may be performed by displaying one or more video images on the display unit 274 (if provided as a video display unit) and/or causing one or more sound segments, such as voice or music, to be generated via the speakers 270.

During performance of the attraction sequence, if a potential player makes any input to the gaming unit 54 as determined at block 504, the attraction sequence may be terminated and a game display may be generated on the display unit 274 (if provided as a video display unit) at block 506. The game display generated at block 506 may include, for example, an image of the casino game that may be played on the gaming unit 54 and/or a visual message to prompt the player to deposit value into the gaming unit 54. At block 508, the gaming unit 54 may determine if the player requested information concerning the game, in which case the requested information may be displayed at block 510. Block 512 may be used to determine if the player requested initiation of a game, in which case a game routine 514 may be performed. The game routine 514 could be any one of the game routines disclosed herein, such as one of the five game routines 480, 482, 484, 486, 488, or another game routine.

After the routine 514 has been performed to allow the player to play the game, block 516 may be utilized to determine whether the player wishes to terminate play on the gaming unit 54. If the player wishes to stop playing the gaming unit 54, which wish may be expressed, for example, by selecting a “Cash Out” button, the controller 310 may dispense value to the player at block 518 based on the outcome of the game(s) played by the player. The operation may then return to block 502. If the player did not wish to quit as determined at block 516, the operation may return to block 508.

### Video Poker

Where the gaming unit 54 is designed to facilitate play of a video poker game, the display unit 274 may comprise a video display unit. FIG. 10 is an exemplary display 600 that may be shown on the display unit 274 during performance of the video poker routine 480 shown schematically in FIG. 7. Referring to FIG. 10, the display 600 may include video images 602 of a plurality of playing cards representing the player's hand, such as five cards. To allow the player to control the play of the video poker game, a plurality of player-selectable buttons may be displayed. The buttons may include a “Hold” button 604 disposed directly below each of the playing card images 602, a “Cash Out” button 606, a “See Pays” button 608, a “Bet One Credit” button 610, a “Bet Max Credits” button 612, and a “Deal/Draw” button 614. The display 600 may also include an area 616 in which the number of remaining credits or value is displayed. If the display unit 274 is provided with a touch-sensitive screen, the buttons 604, 606, 608, 610, 612, 614 may form part of the video display 600. Alternatively, one or more of those buttons may be provided as part of a control panel that is provided separately from the display unit 274.

FIG. 12 is a flowchart of the video poker routine 360 shown schematically in FIG. 7. Referring to FIG. 12, at block 620, the routine may determine whether the player has requested payout information, such as by activating the “See Pays” button 608, in which case at block 622 the routine may cause one or more pay tables to be displayed on the display unit 274. At block 624, the routine may determine whether the player has made a bet, such as by pressing the “Bet One Credit” button 610, in which case at block 626 bet data corresponding to the bet made by the player may be stored in the memory of the controller 310. At block 628, the routine may determine whether the player has pressed the “Bet Max Credits” button 612, in which case at block 630 bet data corresponding to the maximum allowable bet may be stored in the memory of the controller 310.

At block 632, the routine may determine if the player desires a new hand to be dealt, which may be determined by detecting if the “Deal/Draw” button 614 was activated after a wager was made. In that case, at block 634 a video poker hand may be “dealt” by causing the display unit 274 to generate the playing card images 602. After the hand is dealt, at block 636 the routine may determine if any of the “Hold” buttons 604 have been activated by the player, in which case data regarding which of the playing card images 602 are to be “held” may be stored in the controller 310 at block 638. If the “Deal/Draw” button 614 is activated again as determined at block 640, each of the playing card images 602 that was not “held” may be caused to disappear from the video display 600 and to be replaced by a new, randomly selected, playing card image 602 at block 642.

At block 644, the routine may determine whether the poker hand represented by the playing card images 602 currently displayed is a winner. That determination may be made by comparing data representing the currently displayed poker hand with data representing all possible winning hands, which may be stored in the memory of the controller 310. If there is a winning hand, a payout value corresponding to the winning hand may be determined at block 646. At block 648, the player's cumulative value or number of credits may be updated by subtracting the bet made by the player and adding, if the hand was a winner, the payout value determined at block 646. The cumulative value or number of credits may also be displayed in the display area 616 (FIG. 10).

Although the video poker routine 480 is described above in connection with a single poker hand of five cards, the routine 480 may be modified to allow other versions of poker to be played. For example, seven card poker may be played, or stud poker may be played. Alternatively, multiple poker hands may be simultaneously played. In that case, the game may begin by dealing a single poker hand, and the player may be allowed to hold certain cards. After deciding which cards to hold, the held cards may be duplicated in a plurality of different poker hands, with the remaining cards for each of those poker hands being randomly determined.

### Video Blackjack

Where the gaming unit 54 is designed to facilitate play of a video blackjack game, the display unit 274 may comprise a video display unit. FIG. 11 is an exemplary display 700 that may be shown on the display unit 274 during performance of the video blackjack routine 482 shown schematically in FIG. 7. Referring to FIG. 11, the display 700 may include video images 702 of a pair of playing cards representing a dealer's hand, with one of the cards shown face up and the other card being shown face down, and video images 704 of a pair of playing cards representing a player's hand, with both the cards shown face up. The “dealer” may be the gaming unit 54.

To allow the player to control the play of the video blackjack game, a plurality of player-selectable buttons may be displayed. The buttons may include a “Cash Out” button 706, a “See Pays” button 708, a “Stay” button 710, a “Hit” button 712, a “Bet One Credit” button 714, and a “Bet Max Credits” button 716. The display 700 may also include an area 718 in which the number of remaining credits or value is displayed. If the display unit 274 is provided with a touch-sensitive screen, the buttons 706, 708, 710, 712, 714, 716 may form part of the video display 700. Alternatively, one or more of those buttons may be provided as part of a control panel that is provided separately from the display unit 274.

FIG. 13 is a flowchart of the video blackjack routine 482 shown schematically in FIG. 7. Referring to FIG. 13, the video blackjack routine 482 may begin at block 720 where it may determine whether a bet has been made by the player. That may be determined, for example, by detecting the activation of either the “Bet One Credit” button 714 or the “Bet Max Credits” button 716. At block 722, bet data corresponding to the bet made at block 720 may be stored in the memory of the controller 310. At block 724, a dealer's hand and a player's hand may be “dealt” by making the playing card images 702, 704 appear on the display unit 274.

At block 726, the player may be allowed to be “hit,” in which case at block 728 another card will be dealt to the player's hand by making another playing card image 704 appear in the display 700. If the player is hit, block 730 may determine if the player has “bust,” or exceeded 21. If the player has not bust, blocks 726 and 728 may be performed again to allow the player to be hit again.

If the player decides not to hit, at block 732 the routine may determine whether the dealer should be hit. Whether the dealer hits may be determined in accordance with predetermined rules, such as the dealer always hit if the dealer's hand totals 15 or less. If the dealer hits, at block 734 the dealer's hand may be dealt another card by making another playing card image 702 appear in the display 700. At block 736 the routine may determine whether the dealer has bust. If the dealer has not bust, blocks 732, 734 may be performed again to allow the dealer to be hit again.

If the dealer does not hit, the outcome of the blackjack game and a corresponding payout may be determined based on, for example, whether the player or the dealer has the higher hand that does not exceed 21, as determined at block 738. If the player has a winning hand, a payout value corresponding to the winning hand may be determined at block 740. At block 742, the player's cumulative value or number of credits may be updated by subtracting the bet made by the player and adding, if the player won, the payout value determined at block 740. The cumulative value or number of credits may also be displayed in the display area 718 (FIG. 11).

### Slots

Where the gaming unit 54 is designed to facilitate play of a video slots game, the display unit 274 may comprise a video display unit. FIG. 14 is an exemplary display 800 that may be shown on the display unit 274 during performance of the slots routine 484 shown schematically in FIG. 7. Referring to FIG. 14, the display 800 may include video images 802 of a plurality of slot machine reels, each of the reels having a plurality of reel symbols 804 associated therewith. Although the display 800 shows five reel images 802, each of which may have three reel symbols 804 that are visible at a time, other reel configurations could be utilized.

To allow the player to control the play of the slots game, a plurality of player-selectable buttons may be displayed. The buttons may include a “Cash Out” button 806, a “See Pays” button 808, a plurality of payline-selection buttons 810 each of which allows the player to select a different number of paylines prior to “spinning” the reels, a plurality of bet-selection buttons 812 each of which allows a player to specify a wager amount for each payline selected, a “Spin” button 814, and a “Max Bet” button 816 to allow a player to make the maximum wager allowable.

FIG. 16 is a flowchart of the slots routine 484 shown schematically in FIG. 7. Referring to FIG. 16, at block 820, the routine may determine whether the player has requested payout information, such as by activating the “See Pays” button 808, in which case at block 822 the routine may cause one or more pay tables to be displayed on the display unit 274. At block 824, the routine may determine whether the player has pressed one of the payline-selection buttons 810, in which case at block 826 data corresponding to the number of paylines selected by the player may be stored in the memory of the controller 310. At block 828, the routine may determine whether the player has pressed one of the bet-selection buttons 812, in which case at block 830 data corresponding to the amount bet per payline may be stored in the memory of the controller 310. At block 832, the routine may determine whether the player has pressed the “Max Bet” button 816, in which case at block 834 bet data (which may include both payline data and bet-per-payline data) corresponding to the maximum allowable bet may be stored in the memory of the controller 310.

If the “Spin” button 814 has been activated by the player as determined at block 836, at block 838 the routine may cause the slot machine reel images 802 to begin “spinning” so as to simulate the appearance of a plurality of spinning mechanical slot machine reels. At block 840, the routine may determine the positions at which the slot machine reel images will stop, or the particular symbol images 804 that will be displayed when the reel images 802 stop spinning. At block 842, the routine may stop the reel images 802 from spinning by displaying stationary reel images 802 and images of three symbols 804 for each stopped reel image 802. The reels may be stopped from left to right, from the perspective of the player, or in any other manner or sequence.

The routine may provide for the possibility of a bonus game or round if certain conditions are met, such as the display in the stopped reel images 802 of a particular symbol 804. If there is such a bonus condition as determined at block 844, the routine may proceed to block 846 where a bonus round may be played. The bonus round may be a different game than slots, and many other types of bonus games could be provided. If the player wins the bonus round, or receives additional credits or points in the bonus round, a bonus value may be determined at block 848. A payout value corresponding to outcome of the slots game and/or the bonus round may be determined at block 850. At block 852, the player's cumulative value or number of credits may be updated by subtracting the bet made by the player and adding, if the slot game and/or bonus round was a winner, the payout value determined at block 850.

Although the above routine has been described as a video slot machine routine in which slot machine reels are represented as images on the display unit 274, actual slot machine reels that are capable of being spun may be utilized instead, in which case the display unit 274 could be provided in the form of a plurality of mechanical reels that are rotatable, each of the reels having a plurality of reel images disposed thereon.

Moreover, it will be recognized that the determination of whether the player should receive a payout corresponding to the outcome of the slots game, an opportunity to play the bonus game, and/or receive a payout corresponding to the outcome of the bonus game may be made before the reels start “spinning.” That is, the outcome of the slots game may be determined shortly after the wager is made and the “Spin” button 814 is depressed, with the animation of the reels (whether mechanical, electro-mechanical, or electrical) being selected according to the outcome to signal the player that a particular outcome has been determined. Likewise, the determination of whether the outcome will provide the opportunity of a bonus game may be made before the animation of the reels, and the outcome of the bonus game before the bonus game is displayed. As a consequence, the order of the determination of the outcome of the slots game or bonus game and the animation of the reels need not be in the order shown in FIG. 16, and, in fact, may be in a different order without departing from the spirit and teaching of this disclosure. Similar remarks may be made in regard to the determinations of the outcomes and animations of the poker and blackjack routines discussed above, and the outcomes and animations of the keno and bingo routines discussed below.

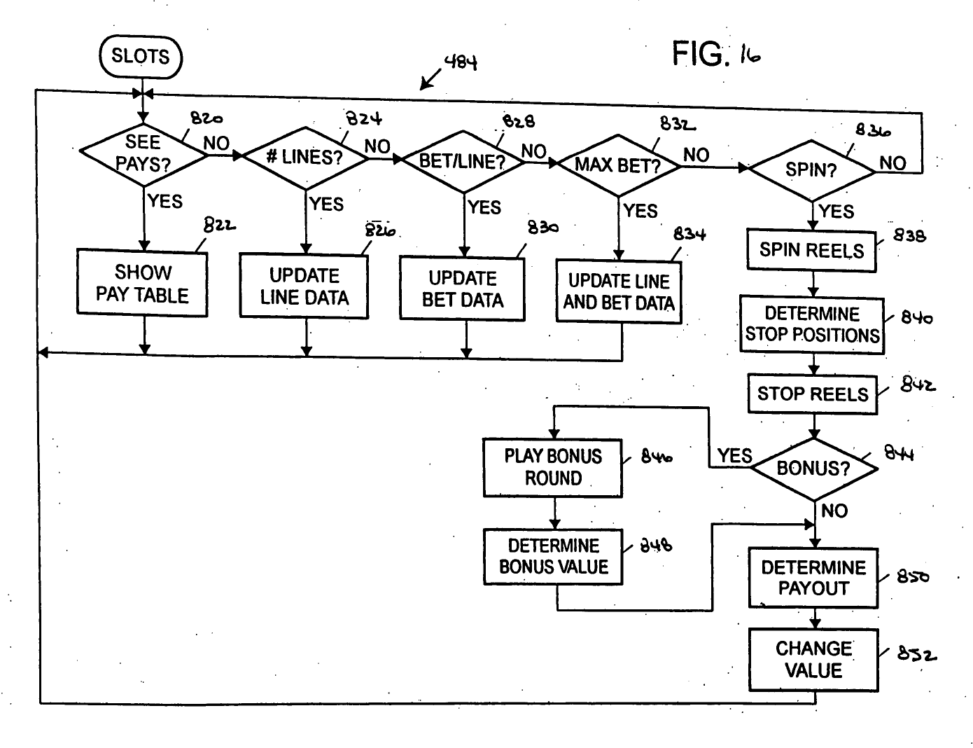

### Video Keno

Where the gaming unit 54 is designed to facilitate play of a video keno game, the display unit 274 may comprise a video display unit. FIG. 15 is an exemplary display 900 that may be shown on the display unit 274 during performance of the video keno routine 486 shown schematically in FIG. 7. Referring to FIG. 15, the display 900 may include a video image 902 of a plurality of numbers that were selected by the player prior to the start of a keno game and a video image 904 of a plurality of numbers randomly selected during the keno game. The randomly selected numbers may be displayed in a grid pattern.

To allow the player to control the play of the keno game, a plurality of player-selectable buttons may be displayed. The buttons may include a “Cash Out” button 906, a “See Pays” button 908, a “Bet One Credit” button 910, a “Bet Max Credits” button 912, a “Select Ticket” button 914, a “Select Number” button 916, and a “Play” button 918. The display 900 may also include an area 920 in which the number of remaining credits or value is displayed. If the display unit 274 is provided with a touch-sensitive screen, the buttons may form part of the video display 900. Alternatively, one or more of those buttons may be provided as part of a control panel that is provided separately from the display unit 274.

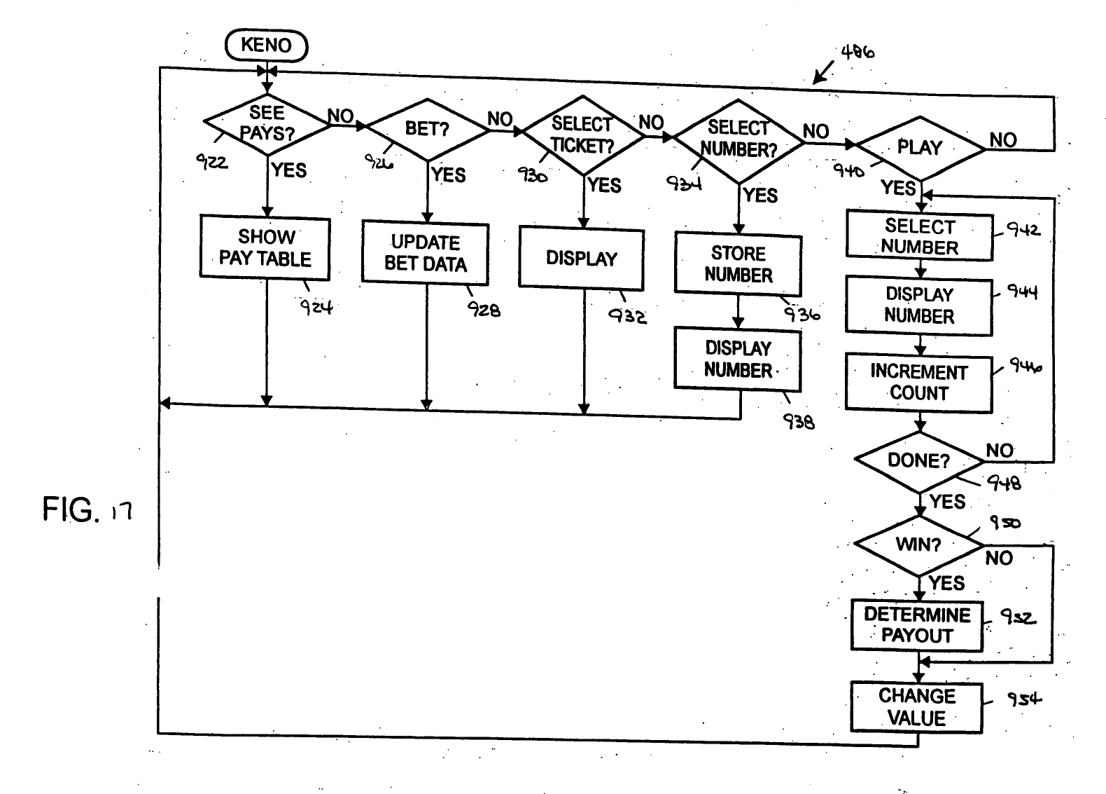

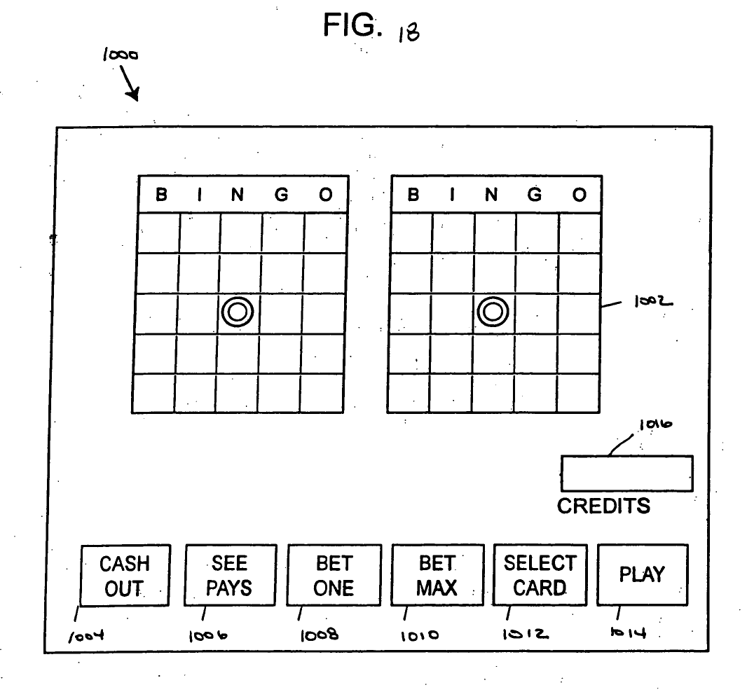

FIG. 17 is a flowchart of the video keno routine 486 shown schematically in FIG. 7. The keno routine 486 may be utilized in connection with a single gaming unit 54 where a single player is playing a keno game, or the keno routine 486 may be utilized in connection with multiple gaming units 54 where multiple players are playing a single keno game. In the latter case, one or more of the acts described below may be performed either by the controller 310 in each gaming unit or by one of the network computer 56, 76, 110 to which multiple gaming units 54 are operatively connected.

Referring to FIG. 17, at block 922, the routine may determine whether the player has requested payout information, such as by activating the “See Pays” button 908, in which case at block 924 the routine may cause one or more pay tables to be displayed on the display unit 274. At block 926, the routine may determine whether the player has made a bet, such as by having pressed the “Bet One Credit” button 910 or the “Bet Max Credits” button 912, in which case at block 928 bet data corresponding to the bet made by the player may be stored in the memory of the controller 310. After the player has made a wager, at block 930 the player may select a keno ticket, and at block 932 the ticket may be displayed on the display 900. At block 934, the player may select one or more game numbers, which may be within a range set by the casino. After being selected, the player's game numbers may be stored in the memory of the controller 310 at block 936 and may be included in the image 902 on the display 900 at block 938. After a certain amount of time, the keno game may be closed to additional players (where a number of players are playing a single keno game using multiple gambling units 54).

If play of the keno game is to begin as determined at block 940, at block 942 a game number within a range set by the casino may be randomly selected either by the controller 310 or a central computer operatively connected to the controller, such as one of the network computers 56, 76, 110. At block 944, the randomly selected game number may be displayed on the display unit 274 and the display units 274 of other gaming units 54 (if any) which are involved in the same keno game. At block 946, the controller 310 (or the central computer noted above) may increment a count which keeps track of how many game numbers have been selected at block 942.

At block 948, the controller 310 (or one of the network computers 56, 76, 110) may determine whether a maximum number of game numbers within the range have been randomly selected. If not, another game number may be randomly selected at block 942. If the maximum number of game numbers has been selected, at block 950 the controller 310 (or a central computer 56, 76, 110) may determine whether there are a sufficient number of matches between the game numbers selected by the player and the game numbers selected at block 942 to cause the player to win. The number of matches may depend on how many numbers the player selected and the particular keno rules being used.

If there are a sufficient number of matches, a payout may be determined at block 952 to compensate the player for winning the game. The payout may depend on the number of matches between the game numbers selected by the player and the game numbers randomly selected at block 942. At block 954, the player's cumulative value or number of credits may be updated by subtracting the bet made by the player and adding, if the keno game was won, the payout value determined at block 952. The cumulative value or number of credits may also be displayed in the display area 920 (FIG. 15).

### Video Bingo

Where the gaming unit 54 is designed to facilitate play of a video bingo game, the display unit 274 may comprise a video display unit. FIG. 18 is an exemplary display 1000 that may be shown on the display unit 274 during performance of the video bingo routine 488 shown schematically in FIG. 7. Referring to FIG. 18, the display 1000 may include one or more video images 1002 of a bingo card and images of the bingo numbers selected during the game. The bingo card images 1002 may have a grid pattern.

To allow the player to control the play of the bingo game, a plurality of player-selectable buttons may be displayed. The buttons may include a “Cash Out” button 1004, a “See Pays” button 1006, a “Bet One Credit” button 1008, a “Bet Max Credits” button 1010, a “Select Card” button 1012, and a “Play” button 1014. The display 1000 may also include an area 1016 in which the number of remaining credits or value is displayed. If the display unit 274 is provided with a touch-sensitive screen, the buttons may form part of the video display 1000. Alternatively, one or more of those buttons may be provided as part of a control panel that is provided separately from the display unit 274.

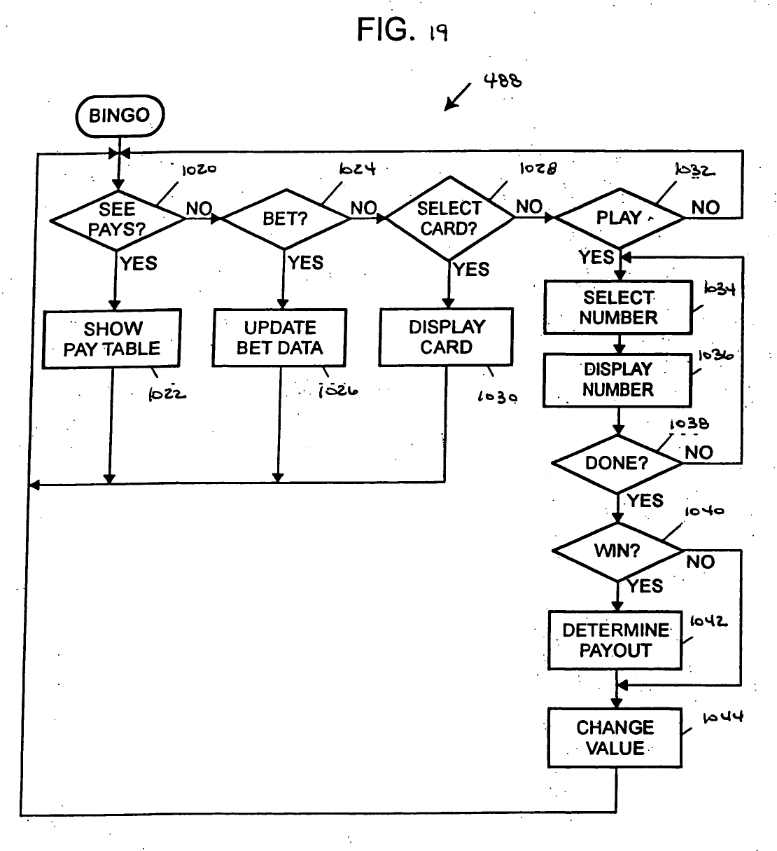

FIG. 19 is a flowchart of the video bingo routine 488 shown schematically in FIG. 7. The bingo routine 488 may be utilized in connection with a single gaming unit 54 where a single player is playing a bingo game, or the bingo routine 488 may be utilized in connection with multiple gaming units 54 where multiple players are playing a single bingo game. In the latter case, one or more of the acts described below may be performed either by the controller 310 in each gaming unit 54 or by one of the network computers 56, 76, 110 to which multiple gaming units 54 are operatively connected.

Referring to FIG. 19, at block 1020, the routine may determine whether the player has requested payout information, such as by activating the “See Pays” button 1006, in which case at block 1022 the routine may cause one or more pay tables to be displayed on the display unit 274. At block 1024, the routine may determine whether the player has made a bet, such as by having pressed the “Bet One Credit” button 1008 or the “Bet Max Credits” button 1010, in which case at block 1026 bet data corresponding to the bet made by the player may be stored in the memory of the controller 310.

After the player has made a wager, at block 1028 the player may select a bingo card, which may be generated randomly. The player may select more than one bingo card, and there may be a maximum number of bingo cards that a player may select. The card or cards may be added to the display 1000 at block 1030. After play is to commence as determined at block 1032, at block 1034 a bingo number may be randomly generated by the controller 310 or a central computer such as one of the network computers 56, 76, 110. At block 1036, the bingo number may be displayed on the display unit 274 and the display units 274 of any other gaming units 54 involved in the bingo game.

At block 1038, the controller 310 (or a central computer) may determine whether any player has won the bingo game. If no player has won, another bingo number may be randomly selected at block 1034. If any player has bingo as determined at block 1038, the routine may determine at block 1040 whether the player playing that gaming unit 54 was the winner. If so, at block 1042 a payout for the player may be determined. The payout may depend on the number of random numbers that were drawn before there was a winner, the total number of winners (if there was more than one player), and the amount of money that was wagered on the game. At block 1044, the player's cumulative value or number of credits may be updated by subtracting the bet made by the player and adding, if the bingo game was won, the payout value determined at block 1042. The cumulative value or number of credits may also be displayed in the display area 1016 (FIG. 18).

### Examples of Operation of System

The following are examples of the operation of the distribution aspect of the system 50 according to an embodiment of the system 50. These examples are for illustration purposes only, and are not meant to limit the scope of the claims thereby, or to emphasize one embodiment discussed above over another.

According to a first example, the e-materials server 130 of FIG. 1A is one of the network computers 110 of FIG. 1, and operates according to the distribution routine illustrated in FIG. 4. Three different players are connected to the gaming and/or distribution aspects of the system 50. The first player is operating one of the gaming units 54 of the network 52 and is logged in to the distribution aspect of the system 50. The second player is operating one of the gaming units 75 of the network 72, and is also operating a personal communication device 84 (in the form of a PDA) that is in communication with the transceiver 82 over an infrared data link 86. The third player is in casino including the third network 92, but is not operating one of the gaming units 94 at the outset of the example, but rather has his cell phone (personal communication unit 122) on and is in communication with the system 50 via the transceiver 120.

The first player is a registered player relative to the distribution aspect of the gaming system 50. Because the player is already logged in to the distribution aspect of the system 50, the player's profile is presently stored in the database associated with the e-materials distribution server 130. According to the player's profile, the player enjoys playing video poker, which the player is presently playing at the gaming unit 54 according to the poker routine 480. The player's profile also indicates that the player is not a member of a player tracking club, but frequently buys scuba equipment from a company that has a site on the Internet. The same scuba equipment company has a sponsor relationship with the operator of the network 52.

The second player is a registered player relative to the distribution aspect of the gaming system 50. At the time the example begins, the second player's profile is not stored in the database associated with the e-materials distribution server 130 because the second player has not yet logged in to the distribution aspect of the system 50. The second player is presently playing video slots on a gaming unit 75 that has a player tracking module 168 associated therewith, the player tracking module 168 being of the type illustrated in FIG. 3 as element 260. As the second player is a member of a player tracking club sponsored by the operator of network 72 and as the second player has placed her card into the card reader 262, the player tracking server 132 is monitoring the number of credits played by the second player at the gaming unit 75. The player tracking server 132 is converting the credits into player tracking points, which points the player may redeem for goods or services as part of the player tracking club. The second player's profile indicated that she enjoys vacations to the Caribbean.

The third player is not logged in to the distribution aspect of the system 50, and is not registered with the distribution aspect of the system 50. However, the third player desires to establish an anonymous registration for the distribution aspect. At the outset, the third player is moving through the casino property that includes the network 92.

Initially, the second and third players log into the system 50 at block 352 of routine 350.

According to the routine 350, the server 130 determines at block 354 that the second player is registered. The routine 350 further determines at block 360 that the profile for the second player has not yet been stored in the associated database. Consequently, at block 390, the profile is retrieved from the personal communication unit 84 associated with the second player and stored in the associated database. The routine 350 then passes to block 392.

The server 130 also determines at block 354 that the third player is not registered to the distribution aspect of the system 50. As such, the routine 350 proceeds to block 356, where an anonymous registration is established for the third player. As the third player desires to preserve his or her anonymity to the greatest degree possible, at block 358, the profile associated with the anonymous registration includes nothing more than an identifier. Further, the identifier selected is an alias—no information is contained in the identifier that can be used to determine the identify of the third player (as opposed to, for example, an identifier that might be used to determine the identify of the player, such as a social security number, for example). The profile thus established would then be stored in the associated profile database. Thus, the server 130 would determine at block 360 that the profile for the third player already existed in the associated database, and pass to block 392.

As a side note, this anonymous registration may be stored in a storage location remote to the server 110 during periods of inactivity for the third player, such as the personal communication unit/cell phone 122 presently being used by the player. Optionally, the server 130 may provide local storage for the anonymous registration, in particular because the type of anonymous registration selected by the third player (identifier only) requires a limited amount of storage space to maintain. Thus, according to this embodiment, the anonymous registration would be as permanent as any other registration to the distribution aspect of the system 50. However, according to another embodiment, anonymous registrations may be temporary, such that the registration and profile is removed from the system once the player indicates that he or she wishes to leave the system; in such a case, the player wishing to use an anonymous registration would have to register anew each time he or she used the distribution aspect.

At block 392, the server 130 would determine if there is a distribution to be made to any or all of the three players. According to this example, the server 130 determines if distributions are to be made according to criterion developed by the network operators 52, 72, 92 (which, according to this example, are associated with a chain of casinos, for which there is a single system-wide operator), rather than making the determinations in response to a request from the units 54, 75, 122 associated with the three players. Moreover, according to this example, the server 130 may determine that an e-coupon with advertising attachment should be distributed to the first player according to a promotional event being sponsored by the scuba equipment company. On the other hand, the server 130 may determine that there are no distributions to be made to the second and third players at this time.

As the server 130 determined at block 392 that a distribution should be made to the first player, the server 130 proceeds to blocks 394, 396 relative to the e-coupon (with advertising materials) that is to be distributed to the third player. According to this example, the e-coupon and associated advertising materials are stored in the database associated with server 130 for later retrieval by the first player. As such, after performing the download of the e-coupon and advertising materials to the database entry associated with the first player, the routine continues to the block 398.

At least initially, the first and second players continue playing their respective games, and the third player continues his passage through the casino property associated with the network 92 of gaming units 94. Consequently, the server determines at block 398 that the players wish to continue use of the distribution aspect of the system 50, and the server 130 proceeds to block 400, where the server monitors the activity of the players and the criterion selected by the network and/or system operators, perhaps monitoring the activity relative to the criterion selected. The server 130 continues to performing this monitoring, which may include downloading of data from the player tracking server 132 concerning the play of the second player, until a determination is made to make a further distribution at block 392 or a player wishes to discontinue use of the distribution aspect of the system 50 at block 402.

As one example, the server 130 may determine that a distribution is to occur at the block 392, and that the distribution is of an e-coupon that will be distributed to all players presently connected to the system. As such, the server 130 may review a list of all registered and anonymous players, and determine which players are presently logged into the distribution aspect of the system 50. According to this example, all three players previously would qualify for such a distribution. According to this example, the server would further determine that both the second and third players had associated personal communication units 84, 122 in communication with the system 50. As such, this particular e-coupon would be downloaded to the units 84, 122. In the case of the first player, because the first player does not have a personal communication unit associated therewith, the e-coupon associated with that player would be stored in the database associated with the server 130 until such time as the first player downloaded the e-coupon. Such a distribution may be made, for example, as part of a promotional event to increase awareness of the distribution aspect of the system 50.

As another example, the server 130 may determine that a distribution is to occur at the block 392, and that the distribution is of an e-coupon to encourage any players connected to the system 50 who are not presently playing a gaming unit to initiate a gaming session, for example, with an offer of a period of free play. In this case, the network 92 may be underutilized, and the server 130 may determine that those players who are in the casinos where the networks 52, 72 are located and who are not presently engaged in a gaming session will be offered the period of free play. Such an e-coupon might be downloaded to a personal communication unit 64, 84, 122, and then uploaded from the personal communication unit 64, 84, 122 to one of the gaming units 94. To carry out this embodiment, he server 130 may send an event and an associated e-coupon for download to the communications computer 60 associated with the network 52 and to the communications computer 80 associated with the network 72. In response to the sent event, the communications computer 60 may determine which players are in communication with the system 50 via the communications computer 60, but not presently engaged in a gaming session at one of the gaming units 54, and communications computer 80 may determine the same relative to the gaming units 72. In this example, the communications computer 80 would determine that the second player, while connected to the system 50, is already engaged in a gaming session. As such, no e-coupon would be provided. Likewise, the first player, who is connected to the system 50 by virtue of the gaming session presently being played on one of the gaming unit 54, would not receive an e-coupon.

As a still further example, the server 130 may determine at block 392 that a distribution is to occur, and that the distribution is to occur to any player that is using the distribution aspect of the system 50 and has achieved a particular number of player tracking points. Accordingly, the server 130 may request information from the player tracking server 132 regarding the players enrolled by the player tracking club associated with the player tracking server 132. In response, the player tracking server 132 may indicate that the second player has earned the appropriate number of points to qualify for the distribution. Accordingly, the server 130 formats the e-coupon, and downloads the e-coupon to the personal communication unit 84 associated with the second player. The second player's personal communication unit 84 registers the receipt of the e-coupon, but provides no further details of regarding the e-coupon and instructions to redeem the e-coupon at the system operator's website.

If the second player were to redeem the e-coupon at the system operator's website at the present time, then the corresponding data stored in the database may indicate that the e-coupon is good for one free beverage at the casino property of her choice. However, the second player does not redeem the e-coupon that night, or for several weeks thereafter. During those several weeks, the second player makes several additional trips to casino properties operated by the operator of system 50. Moreover, the second player uses her player tracking club card each time she visits the casino properties, and earns a considerable number of additional player tracking points. In response to the additional player tracking points earned, the server 130 alters the data stored in the database entry referenced by the e-coupon distributed to the second player. Rather than a free beverage, the entry now reflects that the e-coupon may be redeemed for a trip with an associated third-party vendor. Moreover, drawing on the information provided in the player's profile, the entry may reflect that the e-coupon may be redeemed for a four-day, three-night cruise in the Bahamas. As such, if the second player were to redeem the e-coupon at the present time, the goods or services associated therewith would be considerably different than the goods or services associated with the e-coupon when originally distributed.

As a still further example, and referring now to FIG. 1A, a fourth player may be logged in to the distribution aspect of the system 50 using, for example, the gaming unit 184. The gaming unit 184 may be disposed in a hotel room or a house, for example, and may not only provide gaming operation, but also an Internet connection so that the player may use the gaming unit 184 (or more particularly, browser software operating in the gaming unit 184) to access the World Wide Web. The fourth player may perform searches and access websites at the same time as he or she plays a game, or he or she may access the World Wide Web between games.

As part of the registration, the fourth player may have agreed to permit the system or network operator to monitor his or her use of the Internet as part of his or her use of the distribution aspect of the system 50. For example, the fourth player may permit the server 130 to directly or indirectly monitor his or her access of certain websites. For example, when a particular player accesses a website, for example, of a casino property also operated by the operator that provides the gaming and distribution aspects of the system 50, the player may be prompted to sign in to the website using an identifier associated with his or her distribution player profile. The event of signing in to the website may cause a message to be sent to the server 130, causing the server to make a determination (block 392) that a distribution should be made to the fourth player. Alternatively, the fourth player may access a website administered by a vendor that is partnered with the operator of system 50 and may permit the vendor to recognize the player, when he or she access the vendor's website, through the use of a cookie stored on the gaming unit 184. When the vendor's server accesses the player's cookie, the vendor's server may be programmed to provide a message to the server 130 to determine that a distribution should be made or to adjust a balance stored locally in the vendor's server or remotely in the server 130 that is accessed by the server 130 to determine when a distribution should be made.

If the server 130 determines that a distribution should be made, the server 130 may use the information regarding the fourth player's Internet usage to prepare the materials for distribution at block 394. For example, the fourth player may receive an e-coupon redeemable for a free one-night stay at the casino property corresponding to the website accessed by the fourth player as a consequence of the fourth player being registered for the distribution aspect of the system 50 and having signed in when the player accessed the website. As another alternative, where the fourth player has accessed a web site of a vendor associated with the operator of system 50, the e-coupon prepared for downloading may be redeemable either at the vendor's website or at the vendor's retail establishment.

As yet another example, a fifth player may be registered and logged in to the distribution aspect of the system 50. According to this example and with reference to FIG. 1A, the system 50 may include the sensors 190, and the fifth player may have a personal communication unit 178 that communicates with the sensors 190 over a data link (not shown). In this fashion, the server 130, which is also operatively coupled to the sensors 190, can track the fifth player's use of the casino property associated with the gaming units 172. As a consequence of this information, the server 130 may make determinations regarding distribution at block 392 and the preparation of materials at block 394 according to the player's activities, as reflected in his or her location within the casino property.

For example, the server 130 may determine, in accordance with the data links formed between the sensors 190 and the personal communication device 178 associated with the fifth player, that an e-coupon is to be distributed to the fifth player upon the passage of the fifth player past one of the sensors 190 associated with a restaurant located on the casino property. At block 394, the server 130 may determine that the e-coupon to be distributed is a coupon for a free steak dinner at the restaurant that the player just entered. Alternatively, the server 130 may determine that the e-coupon has a “morphable” characteristic, that the redemption of the e-coupon will vary according to where and when the fifth player redeems the e-coupon, and that redemption of the e-coupon at the present time and at the present location will entitle the fifth player to a steak dinner. By contrast, if the same e-coupon were used at an associated bar, for example, the e-coupon might be redeemable for three drinks. The server 130 may also cause an advertisement or reminder message to be downloaded to the player's personal communication device 178 to alert the player to the e-coupon.

Along, similar lines, the server 130 may use the fifth player's location to advise the fifth player of e-coupons already distributed, not yet redeemed—but redeemable, according to the location of the player within the casino property. For example, the server 130 may have distributed an e-coupon for a steak dinner to the fifth player in accordance with an outcome determined for a poker hand won by the player at one of the gaming units 172. The e-coupon may not have yet been downloaded to the player's personal communication unit 178, but may remain stored in a database associated with the server 130. However, when the fifth player passes by a restaurant where the e-coupon may be redeemed, the server 130 may determine at block 392 that there are materials to be distributed, prepare a reminder message concerning the e-coupon at block 394, and download the reminder message to the personal communication device 178 at the block 396. In this fashion, the fifth player may be reminded of the e-coupon so that the e-coupon may be redeemed.

What is claimed is:

1. A gaming method comprising:
determining if a first event has occurred;
distributing an e-coupon to a player if the first event has occurred, the e-coupon being storable on a machine accessible medium, having an identifier associated therewith, and redeemable for a payout;
associating a first payout with the identifier according to the first event;
determining if a second event has occurred; and
associating a second payout with the identifier according to the second event, the second payout being different than the first payout and the first payout no longer associated with the identifier.

2. The gaming method according to claim 1, comprising:
receiving a wager from the player;
displaying an image representing a game;
determining an outcome associated with the game represented by the image; and
determining if one of the first event and the second event has occurred according to the outcome.

3. The gaming method according to claim 2, comprising:
receiving another wager from the player;
displaying another image representing another game;
determining another outcome associated with the another game presented by the another image; and
determining if the second event has occurred according to the another outcome.

4. The gaming method according to claim 2, comprising:
determining a location of the player within a casino; and
determining if a second event has occurred according to the location of the player within the casino.

5. The gaming method according to claim 2, comprising:
determining at least one of a time of day, week, month and year; and
determining if a second event has occurred according to at least one of a time of day, week, month and year.

6. The gaming method according to claim 1, comprising:
receiving a wager from the player;
displaying a first image representing a game;
determining if a bonus trigger event has occurred;
displaying a second image representing a bonus game;
determining a bonus outcome associated with the bonus game represented by the second image; and
determining if the first event has occurred according to the bonus outcome.

7. The gaming method according to claim 1, comprising:
associating a first payout with the identifier according to the first event without displaying the first payout to the player; and
associating a second payout with the identifier according to the second event without displaying the second payout to the player, the second payout being different than the first payout and the first payout no longer associated with the identifier.

8. The gaming method according to claim 7, comprising:
determining if the player has met an access requirement; and
displaying at least one of the first and second payouts to the player if the player has met the access requirement.

9. The gaming method according to claim 8, comprising:
determining a location of the player within a casino; and
determining if the player has met the access requirement according to the location of the player within the casino.

10. The gaming method according to claim 8, comprising:
determining at least one of a time of day, week, month and year; and
determining if the player has met the access requirement according to the at least one of a time of day, week, month and year.

11. The gaming method according to claim 8, comprising:
receiving a wager from the player; and
determining if the player has met the access requirement according to the wager received from the player.

12. The gaming method according to claim 1, comprising:
distributing the second payout to the player in exchange for the e-coupon, the e-coupon no longer being associated with the player after the distribution of the second payout occurs.

13. The gaming method according to claim 1, wherein the first and second payouts are at least one of a good and a service.

14. A gaming system comprising:
a distribution computer having a processor and memory operatively coupled to the processor,
the distribution computer being programmed to determine if a first event has occurred;
the distribution computer being programmed to distribute an e-coupon to a player if the first event has occurred, the e-coupon being storable on a machine accessible medium, having an identifier associated therewith, and redeemable for a payout;
the distribution computer being programmed to associate a first payout with the identifier according to the first event;
the distribution computer being programmed to determine if a second event has occurred; and
the distribution computer being programmed to associate a second payout with the identifier according to the second event, the second payout being different than the first payout and the first payout no longer associated with the identifier.

15. The gaming system according to claim 14, comprising:
a gaming apparatus including:
a value input device;
a display unit; and
a controller having a processor and a memory operatively coupled to the processor, the controller operatively coupled to the value input device and the display unit,
the controller being programmed to receive a wager from the player;
the controller being programmed to display an image representing a game;
the controller being programmed to determine an outcome associated with the game represented by the image; and
wherein the distribution computer is programmed to determine if one of the first event and the second event has occurred according to the outcome.

16. The gaming system according to claim 15, wherein:
the controller is programmed to receive another wager from the player;
the controller is programmed to display another image representing another game;
the controller is programmed to determine another outcome associated with the another game presented by the another image; and
the distribution computer is programmed to determine if the second event has occurred according to the another outcome.

17. The gaming system according to claim 15, wherein:
the distribution computer is programmed to determine a location of the player within a casino; and
the distribution computer is programmed to determine if a second event has occurred according to the location of the player within the casino

18. The gaming system according to claim 15, wherein:
the distribution computer is programmed to determine at least one of a time of day, week, month and year; and
the distribution computer is programmed to determine if a second event has occurred according to the at least one of a time of day, week, month and year.

19. The gaming system according to claim 14, comprising:
a gaming apparatus including:
a value input device;
a display unit; and
a controller having a processor and a memory operatively coupled to the processor, the controller operatively coupled to the value input device and the display unit,
the controller being programmed to receive a wager from the player;
the controller being programmed to display a first image representing a game;
the controller being programmed to determine if a bonus trigger event has occurred;
the controller being programmed to display a second image representing a bonus game;
the controller being programmed to determine a bonus outcome associated with the bonus game represented by the second image; and
wherein the distribution computer is programmed to determine if the first event has occurred according to the bonus outcome.

20. The gaming system according to claim 14, wherein:
the distribution computer is programmed to associate a first payout with the identifier according to the first event without displaying the first payout to the player; and
the distribution computer is programmed to associate a second payout with the identifier according to the second event without displaying the second payout to the player, the second payout being different than the first payout and the first payout no longer associated with the identifier.

21. The gaming system according to claim 20, wherein:
the distribution computer is programmed to determine if the player has met an access requirement; and
the distribution computer is programmed to cause a display unit to generate and image regarding at least one of the first and second payouts to the player if the player has met the access requirement.

22. The gaming system according to claim 21, wherein:
the distribution computer is programmed to determine a location of the player within a casino; and
the distribution computer is programmed to determine if the player has met the access requirement according to the location of the player within the casino.

23. The gaming system according to claim 21, wherein:
the distribution computer is programmed to determine at least one of a time of day, week, month and year; and
the distribution computer is programmed to determine if the player has met the access requirement according to the at least one of a time of day, week, month and year.

24. The gaming system according to claim 21, wherein:
the distribution computer is programmed to determine if a wager has been received from the player; and
the distribution computer is programmed to determine if the player has met the access requirement according to the wager received from the player.
